(19) United States
(12) Patent Application Publication
(10) Pub. No.: US 2021/0107225 A1
(43) Pub. Date: Apr. 15, 2021

(54) CONTAINER WITH HOLLOW HANDLE

(71) Applicant: HEWLETT-PACKARD DEVELOPMENT COMPANY, L.P., Spring, TX (US)

(72) Inventors: David C Harvey, Fort Collins, CO (US); Kevin E Swier, Corvallis, OR (US)

(21) Appl. No.: 16/499,294

(22) PCT Filed: Oct. 5, 2017
(86) PCT No.: PCT/US2017/055268

§ 371 Date: Sep. 29, 2019

(51) Int. Cl. B29C 64/259; B33Y 40/00; B28B 13/02; B28B 1/00; B22F 12/50; B33Y 30/00

(52) U.S. Cl. CPC B29C 64/259; B33Y 40/00; B33Y 30/00; B28B 1/001; B22F 12/50; B28B 13/02

(57) ABSTRACT

A container comprises a shell including a main portion to store a printing material for a 3D printer. The shell includes an openable end and an opposite close end. The closed end includes an end wall of the main portion and includes a hollow handle portion spaced apart from the end wall. The hollow handle portion is in fluid communication with the main portion.

### BACKGROUND

Additive manufacturing may revolutionize design and manufacturing in producing three-dimensional (3D) objects. At least some forms of additive manufacturing may sometimes be referred to as 3D printing. Various types of materials may be used as a printing material to form the 3D objects.

### BRIEF DESCRIPTION OF THE DRAWINGS

FIG. 1 is a block diagram schematically representing an example container.

FIG. 2A is a partial side view schematically representing one end of an example container.

FIGS. 2B-2C are each a side sectional view schematically representing an example material conveyance arrangement within an example container.

FIG. 3 is a diagram schematically representing an array of cross-sectional profiles of different example containers, such as taken along lines 3-3 of FIG. 1.

FIG. 4A is a side view schematically representing an example container.

FIG. 4B is an end view schematically representing an example container.

FIG. 4C is a side sectional view as taken along lines 4C-4C of FIG. 4B.

FIG. 5A is a partial sectional view of the elongate segment of an example handle portion as taken along lines 5A-5A of FIG. 4B.

FIG. 5B is a diagram schematically representing an array of cross-sectional profiles of different elongate segments of a handle portion, such as taken along lines 5A-5A of FIG. 4B.

FIG. 6 is a side view schematically representing slidable insertion of an example container within a receiving portion of a material supply of a 3D printer.

FIG. 7 is an end view schematically representing an example container upon slidable insertion within an example receiving portion of a material supply.

FIG. 8 is a block diagram schematically representing an example 3D printer.

FIG. 9 is an isometric view schematically representing an example container.

FIG. 10 is a top plan view schematically representing an example container.

FIG. 11 is a bottom isometric view schematically representing an example container.

FIG. 12 is a sectional view as taken along lines 12-12 of FIG. 13.

FIG. 13 is a side sectional view as taken along lines 13-13 of FIG. 10.

FIG. 14 is an isometric view schematically representing an example container.

FIG. 15 is a top plan view schematically representing an example container.

FIG. 16 is a bottom isometric view schematically representing an example container.

FIG. 17 is a partial sectional view as taken along lines 17-17 of FIG. 15.

FIG. 18 is a side sectional view as taken along lines 18-18 of FIG. 14.

FIG. 19 is an isometric view schematically representing an example container.

FIG. 20 is a top plan view schematically representing an example container.

FIG. 21 is a bottom isometric view schematically representing an example container.

FIG. 22 is an isometric sectional view as taken along lines 22-22 of FIG. 20.

FIG. 23A is a partial side sectional view as taken along lines 23A-23A of FIG. 19.

FIG. 23B is a side view schematically representing an example container.

FIG. 24A is a diagram schematically representing an array of example handle portions having different rotational orientations and/or off-center positions.

FIGS. 24B-24C are each a partial side sectional view schematically representing an example handle portion of an example container.

FIG. 25A is an isometric view schematically representing an example container.

FIG. 25B is an end view schematically representing an example container.

FIG. 26A is a bottom isometric view schematically representing an example container.

FIG. 26B is a partial bottom plan view schematically representing an example handle portion of an example container.

FIG. 27 is an isometric sectional view as taken along lines 27-27 of FIG. 25A.

FIG. 28 is a side sectional view as taken along lines 28-28 of FIG. 25A.

FIGS. 29A-29B are each a diagram schematically representing a volume of an example container.

FIG. 30A is a block diagram schematically representing an example control portion.

FIG. 30B is a block schematically representing an example user interface.

FIG. 30C is a block schematically representing an example 3D printing instruction engine.

FIG. 31 is a flow diagram schematically representing an example method of 3D printing an example container.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

At least some examples of the present disclosure are directed to a container to store a printing material for 3D printing, such as a powder printing material or other types of printing materials. In some instances, the material may be referred to as a build material. Numerous examples of such printing or printing materials are described later. In some examples, 3D printing may sometimes be referred to as additive manufacturing. In particular, at least some examples are directed to a container comprising a handle, such as for carrying and/or guiding insertion of the container into a receiving portion of a material supply of a 3D printer. In some examples, the handle may comprise a hollow handle, a handle to facilitate correct insertion of the container, and/or a handle to increase a storage capacity of the container.

In some examples, the container may be used for 2D printing and store materials such as toner, developer, related agents, or other marking agents.

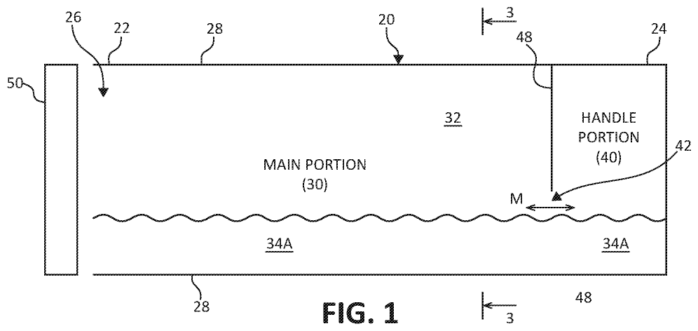

At least these examples, and additional examples, are described and illustrated in association with at least FIGS. 1-31.

FIG. 1 is a block diagram schematically representing an example container 20. As shown in FIG. 1, container 20 comprises a main portion 30 and a handle portion 40. The container 20 comprises an open end 22 and an opposite closed end 24, with a side wall 28 extending between the respective opposite ends 22, 24. In some examples, the container 20 comprises an elongate hollow structure, which may sometimes be referred to as a shell or reservoir, which defines a cavity 26 to store a printing material such as a printing material 34A. It will be understood that the printing material 34A is depicted in FIG. 1 as partially filling container 20 for illustrative clarity and that in some instances, the printing material 34A may fill over half, two-thirds, three-fourths, or the entire volume of the container 20.

In some examples, the open end 22 of container 20 also provides access for initial filling of the printing material 34A into container 20 before placement of element 50 to retain the printing material 34A.

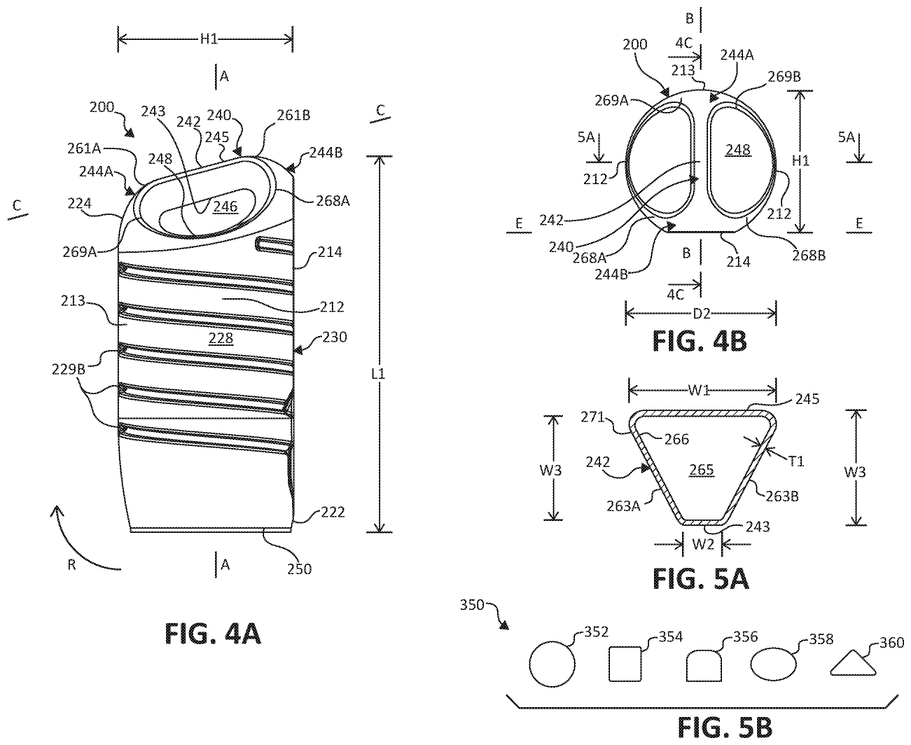

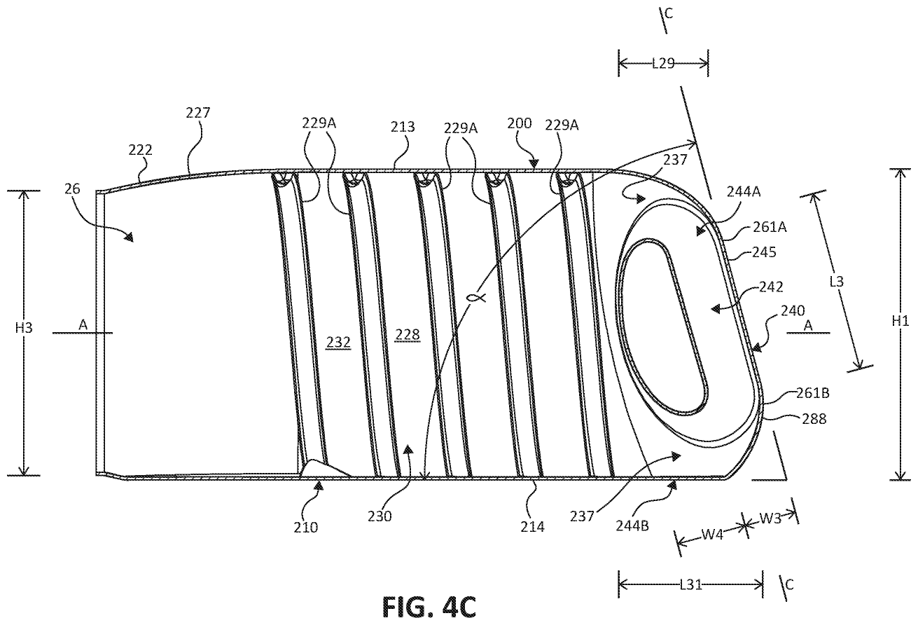

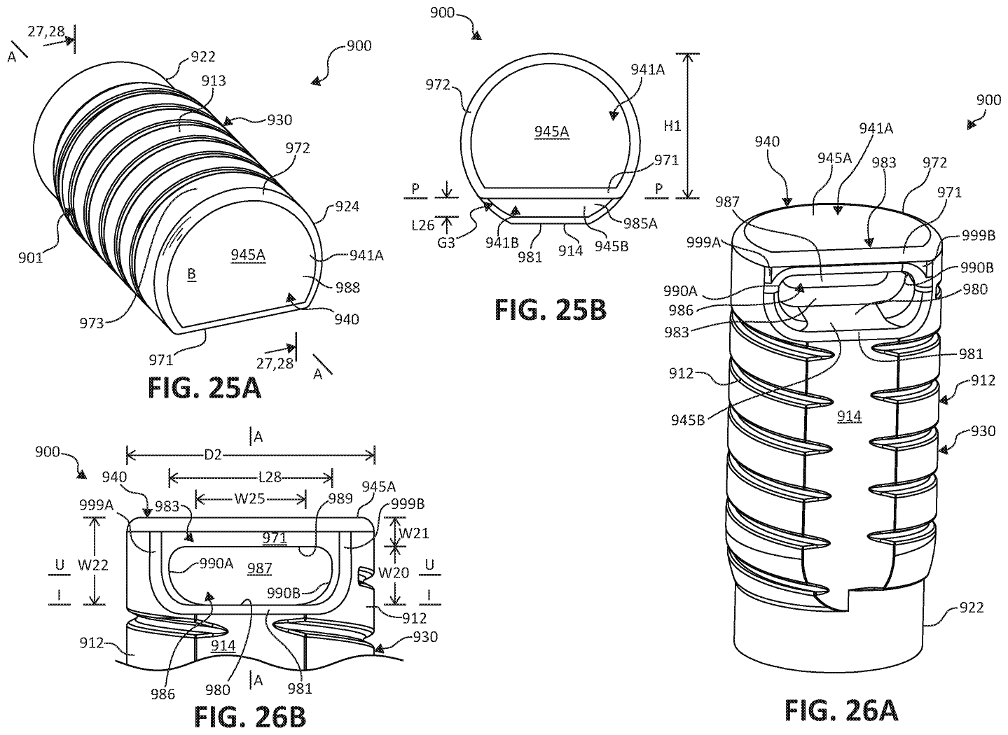

In some examples, the container 20 includes an end wall 48 or similar structure to at least partially define a boundary or transition between main portion 30 and the handle portion 40. In some examples, end wall 48 comprises at least one opening 42 through which printing material 34A may migrate back and forth (as represented by directional arrow M) between the main portion 30 and the handle portion 40 during rotation or other movement of container 20, as more fully described later in association with at least FIG. 7. In some examples, the at least one opening 42 may comprise a single opening, such as shown in FIG. 1 or as later described in association with at least FIGS. 25A-28. However, in some examples, the at least one opening 42 may comprise a pair of openings at opposite end portions of the end wall 48, such as later described in association with the examples FIGS. 4A-23. Moreover, in some examples, the at least one opening 42 may comprise at least two openings through which material may migrate between the main portion 30 and the handle portion 40.

In some examples, the handle portion 40 and main portion 30 may be molded as a single unitary piece. In some instances, the single unitary piece may be referred to as being monolithic. However, in some examples, the handle portion 40 and main portion 30 may be separate components which are assembled into a single component. In some examples, the handle portion 40 may be viewed as an extension of the main portion 30 or as a loop portion extending from the main portion 30 and therefore sometimes may not necessarily be referred to as being a handle.

In some examples, the handle portion 40 may be a separate component which is removably attachable to the main portion 30 by a user.

The handle portion 40 may comprise a variety of shapes and/or sizes, at least some of which are described and illustrated later in association with at least FIGS. 4A-7 and 9-28.

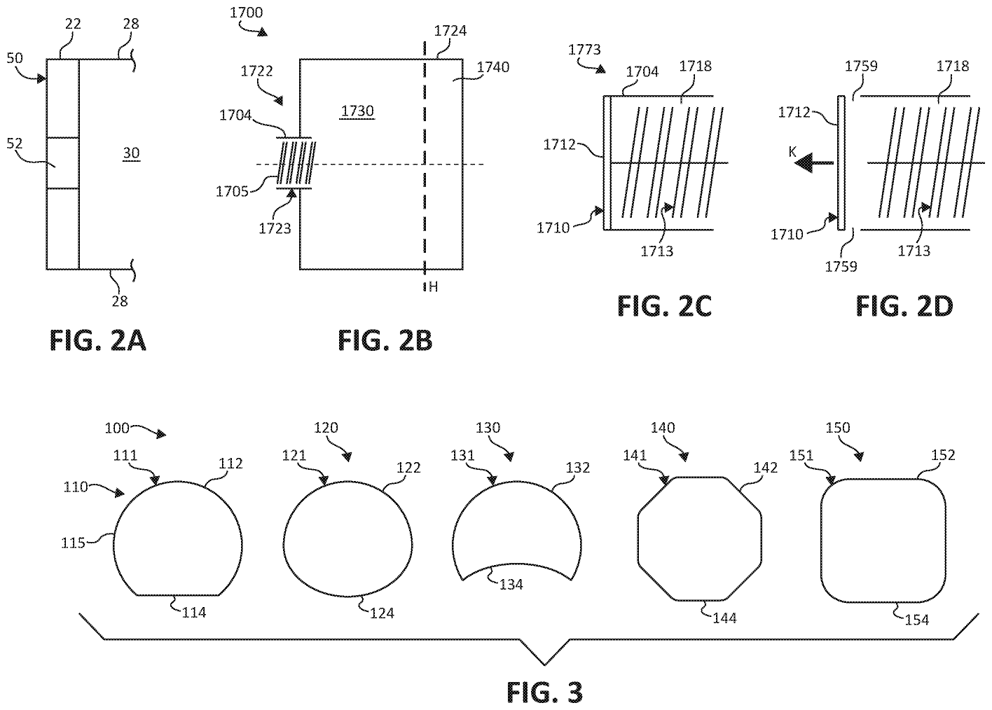

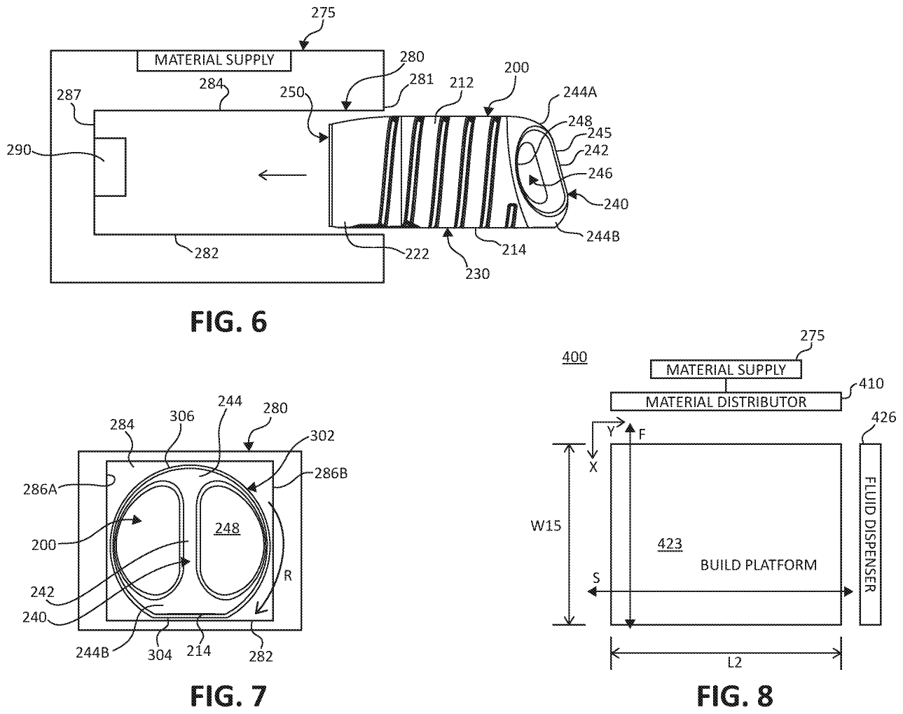

In some examples, as shown in FIG. 2A, element 50 may be removably secured relative to open end 22 of container 20 to selectively retain printing material stored within container 20. In some examples, the element 50 may comprise a structure 52 to permit selective release of printing material 34A from within container 20 out through structure 52 of element 50 or selective re-entry of the printing material into container 20 through structure 52 of element 50, as represented by directional arrow V. In some examples, the printing material may move into or out of container 20 relative to a material supply of a 3D printer (FIG. 6-8) or element of a 3D printing system. The structure 52 may take a wide variety of forms, such as screw or other material conveying element. In some examples, a portion of the structure 52 may protrude into and within a portion of an interior 32 of the main portion 30. As further described in association with at least FIG. 6, in some examples, the structure 52 may operate, in combination with a first rotational movement of the container 20, in order to facilitate withdrawing printing material from within container 20 or in combination with an opposite second rotational movement of the container to permit re-entry of the printing material back into container 20.

With at least some of these arrangements of element 50 and structure 52 in mind, in some instances the container 20 may sometimes be referred to as comprising an openable end 22 to refer to the container 20 being closed at end 22 via element 50 but selectively openable in association with structure 52 to selectively permit withdrawal of material from container 20 and/or selectively permit return of material into container 20.

However, in some examples, when container 20 is not in use to store a printing material, element 50 and/or structure 52 may be absent from open end 22 such as prior to assembly of container 20 or upon dismantling and reassembly of container 20. In such examples, the end 22 may no longer be referred to as being openable but rather merely an open end 22.

FIGS. 2B-2D relate to just one example material conveying arrangement of many possible different material conveying arrangements which may be locatable at or within open end 22 of a container 20, thereby making end 22 an openable end of container 20. In some examples, the container 1700 comprises at least some of substantially the same features and attributes as container 20 and/or the later described example containers in association with FIGS. 4A-7 and 9-29B.

As shown in FIG. 2B, container 1700 comprises a main portion 1730 and hollow handle portion 1740 at closed end 1724, with dashed line H representing a boundary or transition between the main portion 1730 and handle portion 1740. An openable end 1722 comprises a material-conveying arrangement 1723 including a channel 1704 within which at least partially extends a screw 1705 to facilitate moving material through channel 1704 to move material into or out of container 1700.

The screw 1705 may be a helical screw and in some examples is mounted to prevent rotation relative to channel 1704, such that rotation of container 1700 leads to rotation of screw 1705. The screw 1705 and channel 1704 may rotate together to convey material through arrangement 1723, such as upon rotation of the whole container 1700 about axis A. Rotation in a first direction may cause material to move out of container 1700, while rotation in an opposite second direction may cause material to move into container 1700.

FIG. 2C comprises a portion 1773 of an example container based on container 1700 in FIG. 2B, except with a material conveying arrangement embodied as comprising a valve structure 1710 including seal 1712 and screw 1713 which protrudes into an open interior 1718 of channel 1704. Screw 1713 may have the same properties and structure as screw 1705. In some examples, when the valve structure 1710 is in the position shown in FIG. 2C, seal 1712 prevents ingress or egress of material through channel 1704. However, when the valve structure 1710 is moved to the position shown in FIG. 2D, openings 1759 are formed relative to an end of channel 1704 and through which screw 1713 may facilitate movement of material into or out of channel 1704 (and therefore into or out of openable end 1722 of container 1700) upon rotation of container 1700. While not shown in FIGS. 2B-2D for illustrative simplicity, container 1700 and/or material conveying arrangement 1723 may comprise additional elements to facilitate material movement along screw 1705, 1713.

In some instances, the valve structure 1710 may sometimes be referred to as an input/output valve through which printing material may be selectively moved in and out of the openable end 1722 of the container 1700 depending a direction of rotation of the container 1700 about a central longitudinal axis of the container. In some such examples, the input/output valve also may rotate about the same central longitudinal axis.

FIG. 3 is a block diagram schematically representing an array 100 of cross-sectional profiles of different example containers, such as taken along lines 3-3 of FIG. 1. As shown in FIG. 3, array 100 includes an example container 110 having a cross-sectional profile 111 including an arcuate first outer edge portion 112 and generally planar, second outer edge portion 114.

In some examples, the second outer portion 114 may correspond to a bottom surface of the main portion 30 of container 20 while the first outer edge portion 112 may correspond to a top surface and side surfaces of the main portion 30 of container 20. Together, these respective outer edge portions 112, 114 comprise a side wall 115 or shell defining a cavity to store and permit flowability of a printing material. In some examples, the first outer edge portion 112 may comprise an at least semi-circular shape, corresponding to an at least partially cylindrical side wall of the container, such as later further shown in at least FIGS. 4A-4C. In some instances, second outer edge portion 114 may comprise a generally planar shape, such as later shown in at least FIGS. 4A-4C, and may sometimes be referred to as being a flat portion or flat section.

As further shown later in association with at least FIGS. 4A-7, the generally planar section 114 may contribute to stability of the container 110 when placed on a shelf for storage and/or to facilitate a correct orientation (in association with a handle portion 40) during insertion of the container into receiving portion of a 3D printer.

As further shown in FIG. 3, array 100 also comprises an example container 120 having a cross-sectional profile 121 including a generally convex, arcuate first outer edge portion 122 and a generally convex arcuate second outer edge portion 124. Container 120 comprises at least some of substantially the same features and attributes as container 110, except with generally convex arcuate second outer edge portion 124 replacing the generally flat section 114 in the cross-sectional profile 111 of container 110. The second outer edge portion 124 has a radius of curvature different than a radius of curvature of the first outer edge portion 122 such that the second outer edge portion 124 may facilitate correct orientation, in association with a handle portion (e.g. 40 in FIG. 1), in a manner similar to flat section 114 of container 110. In one aspect, the arcuate shape of the second outer edge portion 124 also may enhance flowability of the printing material within container 120.

As further shown in FIG. 3, array 100 also comprises an example container 130 having a cross-sectional profile 131 including a generally convex, arcuate first outer edge portion 132 and a generally concave, arcuate second outer edge portion 134. Container 130 comprises at least some of substantially the same features and attributes as container 110, except for having the concave arcuate second outer edge portion 134 to facilitate correct orientation of container 130 for slidable insertion as previously described for container 110.

As further shown in FIG. 3, array 100 also comprises an example container 140 having an n-gon-shaped cross-sectional profile 141 with a first outer edge portion 142 and second outer edge portion 144. While the container 140 shown in FIG. 3 is a hexagonal shape, it will be understood that other n-gon shapes can be used, such as a pentagon, octagon, etc. Container 140 comprises at least some of substantially the same features and attributes as container 110, such as having at least one bottom flat portion 144 (as second outer edge portion 144) to facilitate correct orientation for slidable insertion and/or stable shelf storage, as previously described for container 110.

As further shown in FIG. 3, array 100 also comprises an example container 150 having a rectangular-shaped cross-sectional profile 151 including first outer edge portion 152 and a second outer edge portion 154 providing at least one flat portion similar to flat portion 114 of container 110. The rectangular shape may have four equal sides, or two sides having a length different from a length of the remaining two other sides. Container 150 comprises at least some of substantially the same features and attributes as container 110, such as having at least one bottom flat portion 154 to facilitate correct orientation for slidable insertion and/or stable shelf storage, as previously described for container 110.

It will be understood that at least some examples of the cross-sectional profiles (e.g. 131, 141, 151) of the containers in FIG. 3 (e.g. 130, 140, 150) comprise rounded corners to facilitate flowability of a printing material within the container as the container is manipulated to facilitate flow of the printing material out of the container for use in a 3D printer, as further described later in association with at least FIGS. 6-7.

In some examples, the cross-sectional profiles of the example containers of array 100 may be shaped and/or sized to facilitate releasable engagement within and relative to a frame (such as frame 302 as later described in association with at least FIG. 7), which in turn may selectively rotate the container to facilitate withdrawing printing material from the container or entry of printing material into container. In some such examples, a rotational axis of the container is aligned with a longitudinal axis of the container.

It also will be understood that in some examples, one of the example cross-sectional profiles of containers 121, 131, 141, 151 in FIG. 3 may be substituted for the cross-sectional profile 111 of at least a main portion of the containers shown in the examples of FIGS. 4A-7 and 9-28.

FIG. 4A is a side view schematically representing an example container 200. In some examples, container 200 comprises at least some of substantially the same features and attributes as previously described in association with at least container 20 (FIGS. 1-2) and/or container 110 (FIG. 3). As shown in FIG. 4A, container 200 comprises a main portion 230 and a handle portion 240. Container 200 includes an openable end 222 and opposite closed end 224, which is at least partially defined by handle portion 240 and an end wall 248 of main portion 230. Like container 20, in some examples both the main portion 230 and handle portion 240 may be hollow, as shown in the sectional views of FIGS. 4C and 5A. Moreover, the hollow handle portion 240 may be in fluid communication with a hollow interior of the main portion 230 in a manner previously described in FIG. 1.

In some examples, end wall 248 may be arcuate shaped as shown in at least FIGS. 4A, 4C. However, in some examples, end wall 248 may comprise at least a planar portion which extends generally parallel to a longitudinal axis C of the elongate segment 242 of handle portion 240 (FIG. 4A).

In some examples, the container 200 may have an overall length L1 on the order of 500 millimeters and an outer diameter (D2 in FIG. 4B) on the order of 200 millimeters, and provide a carrying capacity (e.g. volume) of printing material of about 10 liters of printing material (e.g. 34A in FIG. 1). In some such examples, a fully loaded container 200 may have a weight on the order of 5 to 10 kilograms.

In some examples, at least main portion 230 comprises an at least partially cylindrical shape. In some such examples, main portion 230 comprises an outer side wall 228 comprising an arcuate shape forming a portion of a cylinder and a general planar wall portion 214. In some examples, the outer side wall 228 may sometimes be referred to as comprising an at least partially cylindrical shape. In some examples, the arcuately-shaped portion of the outer side wall comprises opposite side portions 212 and a top portion 213 opposite the generally planar portion 214, which may sometimes be referred to as a bottom portion. It will be understood that some portions of the outer side wall 228 may comprise some small grooves, recessed portion, protrusions, etc. which do not otherwise significantly change the overall or general partial cylindrical shape of the top and side portions 213, 212 of outer side wall 228 or the overall or general planar shape of bottom portion 214 of outer side wall 228.

As shown in at least FIG. 4C, in some examples planar bottom portion 214 may comprise a latching element 210, such as at least one recess, to facilitate releasably securing the container 200 upon its insertion within a receiving portion 280 of a material supply 275 of a 3D printer 400 (FIGS. 6-8). Accordingly, in some examples, by facilitating a correct orientation for insertion of the container, the features of the handle portion 240 and container 200 may ensure that the latching feature or similar features on planar bottom portion 214 become properly engaged relative a receiving portion of a material supply of a 3D printer.

As shown in FIGS. 4A-4C, in some examples the dimensional indicator H1 may be used to represent a height or distance between the bottom portion 214 and the top portion 213 of container 200. Meanwhile, indicator D2 represents an outer diameter extending between opposite curved side wall portions 212 of main portion 230.

In some examples, the main portion 230 and/or an elongate segment 242 of the handle portion 240 may comprise a non-circular cross-sectional shape, such that instead of referring to a simple diameter, in some examples a dimensional indicator (e.g. D2, H1, W3) may represent a greatest cross-sectional dimension, such as an average diameter, a greatest span across the cross-sectional shape between opposite sides of the main portion 230 or elongate segment 242, distance between a front surface 243 and back surface 245 of the elongate segment 242, or similar dimension attribute of a cross-section of the main portion 230 and/or elongate segment 242.

As shown in at least FIGS. 4A, 4C, in some examples handle portion 240 comprises an elongate segment 242 with opposite ends 261A, 261B from which respective transition portions 244A, 244B extend to join end wall 248 and the outer side wall 228. In some examples, the elongate segment 242 may sometimes be referred to as an elongate hollow element. As shown in FIG. 4C, in some examples the respective transition portions 244A, 244B comprise a respective pair of spaced apart openings 237 on opposite ends of the end wall 248 and through which the elongate segment 242 is in fluid communication with the interior 232 of the main portion 230. In some examples, the elongate segment 242 of the handle portion 240 is spaced apart from an end wall 248 of main portion 230 to define a void 246 (e.g. space) therebetween.

In some examples, the handle portion 240 may sometimes be referred to as forming a protrusion relative to the end wall 248 of main portion 230 of container 200. In some examples, the handle portion 240 may sometimes be referred to as forming a partial extension of the main portion 230 of container 200.

As further shown in at least FIGS. 4A-4C, the void 246, as defined by the size and shape of elongate segment 242 relative to end wall 248, may provide generous spacing to enable a full-size hand grip on at least the elongate segment 242 of handle portion 240. Among other attributes, enabling a full hand grip facilitates handling of the container 200 which may comprise a significant weight when fully loaded as noted above. Accordingly, in such instances, facilitating a full size grip via handle portion 240 may facilitate secure and steady gripping and handling of container 200.

Moreover, as shown in at least FIG. 4C, the elongate segment 242 forms an acute angle α relative to the generally planar portion 214 of the side wall 228 of container 200, which may further facilitate secure robust gripping of the handle portion 240. In some examples, the angle α may be between about 65 to 85 degrees. In some examples, the angle α may be between about 70 to 80 degrees. In some examples, the angle α may be about 85 degrees.

With this in mind, in some examples FIG. 4A may be viewed as depicting the container 200 in a generally vertical orientation in which the container 200 may be carried with a one-hand grip on the handle portion 240, and as such the angle α of the handle portion 240 facilitates an ergonomically favorable position of the hand (e.g. being slightly angled downward) in firmly grasping the handle portion 240 with the main portion 230 of container 200 extending lengthwise directly below the gripping hand. In some examples, the ergonomically favorable gripping position comprises a forearm and hand being in a neutral position (e.g. a palm would face a side of the body) while the wrist may extend partially in flexion while grasping the handle portion 240.

In one aspect, the angled segment 242 of handle portion 240 may facilitate placement of a thumb of the gripping hand on a back surface 245 of the handle portion 240. This arrangement may enhance robust gripping for carrying and/or may enhance leverage during manual pivoting (as represented by directional arrow R in FIG. 4A) of the container 200 from a vertical orientation (FIG. 4A) into a second, different orientation (FIG. 4B, 6-7), such as when in which the container 200 may be slidably inserted into a receiving portion (e.g. slot) of a material supply of a 3D printer. In some examples, the second orientation may be a horizontal position, i.e. a position in which the container 200 extends generally horizontally.

In some examples, the acute angle (a) formed via elongate segment 242 of handle portion 240 may facilitate the manual pivoting between the vertical orientation (FIG. 4A) and the horizontal orientation (FIGS. 6-7) without involving a change in position of the hand-gripping action on handle portion 240. However, in some such examples, such as when the container is quite heavy (e.g. full of printing material 34A), a second hand of the user may be used to support the main portion 230 while the first hand maintains a firm grip on the handle portion 240 to support and guide the orientation and advancement of the container 200.

Moreover, in situations when the container is heavy such as when the container 200 is full just prior to insertion into a material supply of a 3D printer, a combination of this weight and the acute angle α may facilitate a user maintaining a correct orientation of insertion of the container 200 into a material supply of a 3D printer (FIGS. 6-8). Stated differently, in some examples this combination may inhibit a user from rotating or maneuvering the container 200 into an incorrect orientation in which the container 200 would be misaligned for insertion.

In some examples, the handle portion 240 may be considered a non-pouring handle at least to the extent that the handle portion 240 is at a closed end 224 of the container 200 opposite from the openable end 222 and the handle portion 240 generally is not used to causing tilting of the main portion 230 in order to cause contents (e.g. printing material) to exit the openable end 222 of the container 200. Instead, the handle portion 240 may be used for carrying the container 200 and/or for positioning the container 200 for slidable insertion into a receiving portion of a material supply of a 3D printer. Accordingly, in some instances, the handle may sometimes be referred to as a transport handle, a carrying handle, a positioning handle, an insertion handle, etc.

In some examples, as best seen via the end view of FIG. 4B and side sectional view of FIG. 4C, a longitudinal axis C of the elongate segment 242 of handle portion 240 extends in a plane (represented by lines B-B) which extends generally perpendicular to a plane (represented by lines E-E) through which the generally planar bottom portion 214 extends. Via this arrangement, as best seen in FIG. 4B, the elongate segment 242 of handle portion 240 extends generally perpendicular to a short axis of the generally planar bottom portion 214, which extends through and is represented by plane E. In one aspect, this short axis is generally perpendicular to a longitudinal axis of the generally planar bottom portion 214, which is generally parallel to the central longitudinal axis A of the container 200 (FIGS. 4A, 4C).

Via this arrangement and as shown in FIGS. 4A-4B, in some examples the longitudinal axis C of the elongate segment 242 of the handle portion 240 extends in a plane B common with a central longitudinal axis (A) of the main portion 230 of container 200. In one context, this arrangement corresponds to the elongate segment 242 of the handle portion 240 having a vertically upright orientation relative to the planar bottom portion 214 such that the elongate segment 242 is not tilted or rotated to the left or right when the closed end 224 of the container 200 (including the handle portion 240) is seen from an end view. Via this arrangement, the elongate segment 242 also is aligned with a center of the main portion 230 of container 200.

Via at least some of these arrangements regarding handle portion 240, in some examples the previously-described gripping action on handle portion 240 may automatically align, or at least help substantially align, the planar bottom portion 214 for proper slidable insertion relative to a complementary shaped and sized planar portion of a receiving slot (e.g. slot 280) of a material supply (e.g. 275) of a 3D printer (FIGS. 6-8). Accordingly, this arrangement may inhibit a user from attempting insertion of the container 200 in an improper rotational orientation relative to the receiving portion of the material supply of the 3D printer.

The planar bottom portion 214 provides just one example of an outer edge portion of container 200 which may serve, in cooperation with handle portion 240, to align container 200 in a correct insertion orientation. Moreover, in some examples, container 200 may comprise two different outer edge portions arranged together facilitate alignment in a correct insertion orientation, with a receiving portion of a material supply (e.g. 280, 275 in FIGS. 6-7) comprising a cross-sectional shape which is complementary to both of the two different outer edge portions.

In some examples, at least the elongate segment 242 of handle portion 240 comprises a generally trapezoidal cross-sectional shape as shown in at least FIG. 5A. As shown in FIG. 5A, the elongate segment 242 comprises the previously described back surface 245, an opposite front surface 243, and opposite side surfaces 263A, 263B, with the back surface 245 having a width W1 substantially greater than a width W2 of the front surface 243. In some examples, the substantially greater difference corresponds to a difference of 50%, 100%, 150%, and the like.

In some examples, the relatively wide back surface 245 may generally facilitate hand-gripping of handle portion 240 and/or may specifically facilitate thumb placement and pressure on the back surface 245 to thereby enhance the previously described leverage during manual pivoting of the container 200 from a vertical orientation (FIG. 4A) to a horizontal orientation (FIGS. 6-7), or vice versa. Meanwhile, as shown in FIGS. 4A and 4C, the front surface 243 is spaced apart from, and faces, end wall 248 to provide void 246, as further described throughout various examples of the present disclosure.

Moreover, among other attributes, this example cross-sectional profile of elongate segment 242 of handle portion 240 may facilitate flowability of printing material 34A within, along, and through the elongate segment 242 of handle portion 240 such that the printing material 34A can readily flow between the handle portion 240 and the main portion 230 of the container 200. In this way, in at least some examples the handle portion 240 may provide additional storage capacity for container 200 with little or no interference of movement of printing material 34A between the handle portion 240 and the main portion 230. Accordingly, via this arrangement, the printing material 34A can flow out of the handle portion 240 into the main portion 230 as printing material 34A exits out of (e.g. is drawn out of) the openable end 222 of container 200, such as through element. Similarly, in instances in which material may be permitted entry into main portion 230 via element 250, material may readily enter handle portion 240, such as during rotation of container 200.

In some examples, at least the elongate segment 242 of handle portion 240 comprises an inner cross-sectional area 265 as shown in FIG. 5A (or as shown in FIG. 5B or FIG. 3) which is substantially greater than a particle size of a printing material. In some examples, the particle size may be on the order of tens of microns or on the order of one-hundreds of microns, as more fully described later in association with at least FIG. 8. Accordingly, in some such examples a greatest cross-sectional dimension (e.g. W1 or W3) of the inner cross-sectional area 265 of the elongate segment 242 is on the order of 30 millimeters.

With this in mind, in some examples the above-described substantially greater difference comprises at least one order of magnitude difference. In some examples, this substantially greater difference may comprise at least two orders of magnitude difference. This substantially greater difference may contribute to the flowability of the particles of printing material within, along, and through handle portion 240. In some examples, an inner cross-sectional area of the later described respective transition portions 244A, 244B is also substantially greater (e.g. at least one order of magnitude, at least two orders of magnitude, etc.) than the particle size of the printing material 34A.

In some examples, the handle portion 240 may comprise a wall thickness (T1), hardness, toughness, and strength sufficient to withstand the loaded weight of printing material within the handle portion 240 and main portion 230, as well as resisting fracture and/or denting upon the container 200 being inadvertently mishandled (e.g. dropped, etc.). In some examples, at least the handle portion 240 may be formed of a polymer material, such as high density polyethylene (HDPE), any number of different polymers, or combinations thereof. In some examples, at least some these same materials may be used to form the main portion 230.

In some examples, the inner wall surface 266 (FIG. 5A) of the handle portion 240 and/or of the main portion 230 may comprise a low coefficient of friction. This arrangement may facilitate flowability of the printing material within container 200, including handle portion 240. In some examples, the inner wall surface 266 of the handle portion 240 and/or main portion 230 may comprise a lubricous coating to enhance such flowability.

In some examples, instead of the generally trapezoidal cross-sectional shape shown in FIG. 5A, at least elongate segment 242 of handle portion 240 may comprise a cross-sectional shape such as a circular shape 352, a rectangular shape 354, an at least partially rounded rectangular shape 356, an elliptical shape 358, a triangular shape 360, etc. as shown in the array 350 of FIG. 5B provided that suitable flowability of printing material is provided through the elongate segment 242. In some examples, at least the elongate segment 242 of handle portion 240 may comprise a cross-sectional shape such as any one of the cross-sectional shapes shown and described in association with FIG. 3 or even other suitable shapes.

Moreover, it will be understood that at least a portion of the handle portion of any one of the example containers described in association with FIGS. 1, 9-23 may comprise one of the cross-sectional shapes shown in FIGS. 3, 5B. In addition, in some examples, the cross-sectional shape of the elongate segment of a handle portion of any example container of the present disclosure may vary along a length of the elongate segment of the handle portion. In some examples, for any given cross-sectional shape of an elongate segment of a handle portion of an example container, an outer surface of the elongate segment may further comprise recesses, protrusions, knurled portions, undulations, dimpled portions, friction coatings, rubber coatings, etc. which may enhance the grippability of the elongate segment.

In some examples, as shown in FIG. 5A, at least the elongate segment 242 may comprise an outer wall surface 271 having a first cross-sectional shape which is generally the same as a second cross-sectional shape of an inner wall surface 266 of the elongate segment 242. However, in some examples, at least the elongate segment 242 may comprise an outer wall surface 271 having a first cross-sectional shape which is different from a second cross-sectional shape of an inner wall surface 266 of the elongate segment 242.

With further reference to at least FIGS. 4A-4C, in some examples the handle portion 240 comprises a pair of transition portions 244A, 244B, which include the respective inner surfaces 267A, 267B comprising a smooth, arcuate contour bridging between the end wall 248 and the elongate segment 242 of the handle portion 240. In one aspect, this arrangement facilitates flowability of the printing material between the handle portion 240 and the main portion 230. In some examples, each opening 237 (defined by the respective transition portions 244A, 244B) comprises a cross-sectional area equal to or greater than a cross-sectional area of the elongate segment 242 to promote flowability of printing material out of the elongate segment 242 into the main portion. In some examples, the opening 237 of the lower transition portion 644B comprises a cross-sectional area greater than the cross-sectional area of the upper transition portion 244A.

As shown in FIG. 4C, a width W4 of the void 246 between the front surface 243 of the handle segment 242 and the end wall 248 of main portion 230 is about one-half the outer diameter (D2 in FIG. 4B) of the main portion 230 of the container 200, or is about one-half the height (H1) between top portion 213 and bottom planar portion 214. In some examples, the width W4 of the void 246 may be substantially greater (e.g. 2×, 3×, 4×, etc.) than a width W3 in FIGS. 4C, 5 of the elongate segment 242 of the handle portion 240.

As shown in FIG. 4C, in some examples a length L3 of the void 246 (between the inner surfaces 267A, 267B of the respective opposite transitions portions 244A, 244B) of handle portion 240 may comprise between about 50 percent and 90 percent of an outer diameter (D2 in FIG. 4B) or height (H1 in FIG. 4B) of the main portion 230 of container 200. In some examples, this length L3 of void 246 is at least about 70 percent of the outer diameter D2 (FIG. 4B) or height H1 (FIG. 4A, 4B).

In some examples, this length L3 and width W4 of void 246 may enable the above-described full-gripping of elongate segment 242 of handle portion in which all four fingers may be wrapped about elongate segment 242 with the fingers extending within and/or through the void 246.

In some examples, this length L3 is substantially greater than the diameter W3 of the elongate segment 242. In some examples, in at least this context a substantially greater difference means at least a 2×, 3×, 4× difference. In some examples, a substantially greater difference in this context comprises at least one order of magnitude difference. In some examples, such as when the elongate segment 242 has a non-circular cross-sectional shape, the dimensional indicator W3 may sometimes refer to a greatest cross-sectional dimension, such as an average diameter, greatest span across the cross-sectional shape, distance between a front surface 243 and back surface 245 (e.g. opposite sides), or similar dimensional attribute of a cross-section of the elongate segment 242.

In some examples, as shown in at least FIG. 4C, the lower transition portion 244B has a length L31 which is substantially greater than a length L29 of upper transition portion 644A. In some examples, this substantially greater difference corresponds to a difference of 2×, 3×, 4×. At least in part, this arrangement provides the forward slant of elongate segment 242 to extend at the above-described acute angle α of between about 65 to 85 degrees relative to longitudinal axis A of at least main portion 230 of container 200.

Via this arrangement, as shown in at least FIG. 4C, the second end 261B of the elongate segment 242 corresponds to an utmost end 288 of the container 200, and the opposite first end 261A of the elongate segment 242 is in a position between the openable end 222 of the container 200 and the utmost end 288 of the container 200. Accordingly, in some examples, a side of the container 200 on which the first end 261A of elongate segment 242 is positioned may sometimes be referred to as a side of the container 200 on which the first end 261A of elongate segment 242 is positioned may sometimes be referred to as a short side of container 200 and a side of the container 200 on which the second end 261A of elongate segment 242 is positioned may sometimes be referred to as a long side of container 200

In some examples, as shown in at least FIGS. 4A-4C, a central longitudinal axis (A) of the openable end 222 is in direct alignment with a central longitudinal axis (A) of the main portion 230. In some examples, a central longitudinal axis (A) of the openable end 222 is in direct alignment with a central longitudinal axis (A) of the closed end 224 of container 200, and therefore is aligned generally with at least a portion of the elongate segment 242 of handle portion 240. In some examples, the at least partially cylindrically-shaped cross-sectional area of openable end 222 of container 200 is generally aligned with an at least partially cylindrically-shaped cross-sectional area of the main portion 230 adjacent the end wall 248 of container 200. Via this arrangement, in some examples, the openable end 222 may sometimes be referred to as extending in generally the same partial cylindrical plane as the main portion 230 adjacent closed end 224.

As shown in at least FIG. 4C, in some examples the openable end 222 of container 200 defines a first inner cross-sectional area between about 50 percent and 100 percent of a second cross-sectional area of the main portion 230 of container 200. In some examples, the first cross-sectional area is between about 75 to 85 percent of the second cross-sectional area. In some examples, a diameter and/or height (e.g. H3) of the openable end 222 may be used to determine the first cross-sectional area and a diameter (e.g. D2) and/or height (H1) may be used to determine the second cross-sectional area.

In some examples, a greatest cross-sectional dimension of the openable end 222 may be between about 50 to 100 percent of a greatest cross-sectional dimension of the remainder of the main portion 230 and/or of the closed end 224. In some examples, the greatest cross-sectional dimension of the openable end 222 may be between about 75 percent to 85 percent of the greatest cross-sectional dimension of the remainder of the main portion 230 and/or the closed end 224.

In some such examples the openable end 222 may be generally defined by the outer side wall 228 of the main portion 230 of container 200 and not a separate spout structure. Among other attributes, in some examples this relatively large openable end 222 may facilitate introduction of a structure (e.g. 52 in FIG. 2A) in association with element 250 to protrude within a portion of the interior 232 of the main portion 230 to facilitate withdrawal or re-entry of selective amounts of the printing material relative to the interior 232 of the main portion 230. In some such examples, the openable end 222 and element 250 may comprise at least some of substantially the same features and attributes as previously described in association with at least FIGS. 2B-2D.

In some examples, a portion 227 of the top portion 213 of the outer wall 228 adjacent the openable end 222 may be sloped downward and/or inward relative to the outer wall 228 generally. In some instances, this sloped portion 227 may facilitate insertion of the end 222 of the container 200 into a receiving portion (e.g. 280) of a material supply 275 of a 3D printer. In some examples, the handle portion 240 (including the transitions portions 244A, 244B) comprises about 20 to 25 percent of the overall length L1 of the container 200.

In some examples, the handle portion 240 (including the transition portions 244A, 244B) may be between about 5 to 10 percent of the overall volume (e.g. about 10 Liters in some examples) available to carry a printing material within container 200.

Via such arrangements as described in association with at least FIGS. 4A-5A, printing material stored within container 200 may spontaneously flow out of hollow handle portion 240 into main portion 230 as the level of printing material in the main portion 230 is reduced due to being withdrawn for use in the material supply of a 3D printer. Moreover, placing some of the printing material within the hollow handle portion may enhance an overall weight balance along the length of the container 200. At the same time, utilizing a hollow handle portion 240 (including hollow transition portions 244A, 244B) may enhance volumetric efficiency without unnecessarily extending the overall length of the container 200.

In some examples, by employing a hollow handle portion 240 in fluid communication with a main portion 230, the container 200 may provide an increased volume for generally the same length L1 and diameter D2 (or height H1) as a container lacking a hollow handle portion. Accordingly, container 200 may enhance efficiency in operating a 3D printer by reducing the frequency with which a material supply is to be replenished via a consumable printing material container, such as container 200. This, in turn, may reduce overall operating costs, inventory control costs, storage costs, shipping costs, etc. associated with providing a reliable, timely supply of printing material for a 3D printer.

In one aspect, increasing the load-carrying volume of a supply container (such as via employing a hollow handle) while retaining its general dimensions (e.g. outer diameter, and overall length) may permit use of the container 200 in a receiving portion of existing material supply of a 3D printer without redesigning or remanufacturing the receiving portion of the material supply, as might be indicated if an overall length and/or outer diameter of a container for a material supply were increased.

FIG. 6 is a side view schematically representing slidable insertion of an example container 200 within an example receiving portion of an example material supply 275 of a 3D printer or of an element of a 3D printing system. In some examples, material supply 275 may be in at least fluid communication with a material distributor 410 of a 3D printer 400 as further described later in association with at least FIG. 8. As shown in FIG. 6, the material supply 275 may comprise a receiving portion, such as a slot or opening 280 sized and shaped to removably receive at least a portion of the container 200. In some examples, the slot 280 may comprise an open end 281, opposite end wall 287, a top wall 284, and opposite bottom wall 282.

In some examples, material supply 275 may comprise an engaging mechanism 290 to releasably engage the openable end 222 (including element 250) of container 200 to facilitate selectively draw printing material out of the openable end 222 of container 200 to become available for using in 3D printing or to facilitate entry of printing material into container 200.

FIG. 7 schematically represents an end view of the example container 200 upon slidable insertion within the receiving portion 280 of a material supply 275 of a 3D printer. Accordingly, as further shown in FIG. 7, the bottom wall 282 of slot 280 may comprise a generally flat shape to generally correspond to the generally planar shape of the bottom portion 214 of the container 200. In at least some examples, this complementary juxtaposition of the two generally planar portions help to stably support the container 200 and/or to help ensure a correct orientation of the container 200 within the slot 280. As further shown in FIG. 7, at least from an end view the elongate segment 242 of handle portion 240 extends generally perpendicular to the generally planar portion 214 of container 200 and/or the generally planar bottom wall 282 of slot 280. Among other attributes, this configuration may facilitate slidable insertion of container 200 with a correct orientation relative to slot 280. In at least some instances, this configuration also may facilitate stabilization of the container 200. In particular, when the container is positioned in generally horizontal orientation with the planar bottom portion 214 towards the bottom, the printing material in the container 200 will flow under gravity to lead to a fairly stable weight distribution within container 200.

FIG. 7 depicts slot 280 has having a generally rectangular-shaped cross-sectional shape formed via opposite side walls 286A, 286B, top wall 284, and bottom wall 282. However, in some examples, other than the generally planar bottom wall 282, the remaining walls 286A, 286B, 284 may form a generally arcuate cross-sectional profile which generally corresponds to the generally arcuate cross-sectional profile of the outer sidewall 228 of main portion 230 of container 200.

In some examples, a frame or cage 302 is supported within the slot 280 to slidably receive and securely engage the container 200. In some examples, the frame 302 comprises a generally flat bottom wall 304 and an arcuate upper wall 306 (e.g. top and side walls) defining a cross-sectional shape generally complementing or corresponding to the cross-sectional shape of main portion 230 of container 200. The frame 302 may be controllable to selectively cause rotation of the frame 302 and container 200 about a rotational axis generally aligned with a central longitudinal axis of the container 200, as represented by directional arrow R in FIG. 7. In some examples, rotation in a first direction may facilitate drawing printing material out of the openable end 222 of the container 200 (e.g. through element 250) to become available for use in a 3D printer while rotation in a second direction may facilitate re-entry of printing material into the container 200 through openable end 222. In some examples, the ribs 229A within the main portion 230 (FIG. 4C) may facilitate an inward or outward migration of printing material through openable end 222 depending on the direction of rotation of container 200. In some examples, the handle portion 240 facilitates migration of printing material between the handle portion 240 and the main portion 230 as the printing material becomes automatically re-distributed during withdrawal or re-entry of printing material relative to the main portion 230.

FIG. 8 is a block diagram schematically representing an example 3D printer 400. As shown in FIG. 8, in some examples, the 3D printer 400 comprises components to 3D print (e.g. additively manufacture) an example 3D object. In some examples, the 3D printer 400 may comprise a material distributor 410 and a fluid dispenser 426. Via such an example configuration, 3D printer 400 manufactures 3D object by forming a selectable number of layers of a printing material. This formation includes using material distributor 410 to coat the build platform 423 (or a preceding layer) with a layer of the printing material and then applying a fluid agent (e.g. at least a fusing agent) via dispenser 426 at selectable portions on the current layer. Irradiation of these selectable portions by the energy source results in fusing of the printing material in accordance with the printed patterns. This cycle of coating, dispensing and fusing is repeated until a selected number of layers of printing material is formed into 3D object. Once formed, the 3D object may be separated from the build platform 423.

It will be understood that the material distributor 410 may be implemented via a variety of electromechanical or mechanical mechanisms, such as doctor blades, slot dies, a roller, and/or other structures suitable to spread and/or otherwise form a coating of the printing material in a generally uniform layer relative to the build platform 423 or relative to a previously deposited layer of printing material.

In some examples, the material distributor 410 is capable of coating the entire build platform 423 with a layer of printing material in a single pass or multiple passes as the material distributor 410 travels the width W15 of, and covers the length L2 of, the build platform 423.

In some examples, the material distributor 410 moves in a first orientation (represented by directional arrow F) while the fluid dispenser 426 moves in a second orientation (represented by directional arrow S) generally perpendicular to the first orientation. In some examples, the material distributor 410 can deposit material in each pass of a back-and-forth travel path along the first orientation while the fluid dispenser 426 can deposit fluid agents in each pass of a back-and-forth travel path along the second orientation. In some examples, the material distributor 410 and the dispenser 426 can be arranged to move in the same orientation, either the first orientation (F) or the second orientation (S).

In some examples, the printing material (e.g. 34A in FIG. 1) used to generally form the 3D object comprises a polymer material. In some examples, the polymer material comprises a polyamide material. However, a broad range of polymer materials may be employed as the printing material. In some examples, the printing material may comprise a ceramic material or a metallic material. In some examples, the printing material may comprise a composite of at least some of the above-identified types of printing materials. In some examples, the printing material may take the form of a powder while in some examples, the printing material may take a non-powder form. In some examples, the printing material may comprise liquids, gels, sludges, etc. Regardless of the particular form, the printing material is suitable for spreading, depositing, etc. in a flowable form to produce a coating (via distributor 410) relative to build platform 423 and/or relative to previously coated first layers of the printing material.

The polymeric printing material may be crystalline or semi-crystalline polymers in powder form. Examples of crystalline or semi-crystalline polymers include semi-crystalline thermoplastic materials with a wide processing window of greater than 5° C. (i.e., the temperature range between the melting point and the re-crystallization temperature). Some specific examples of the semi-crystalline thermoplastic materials include polyamides (PAs) (e.g., PA 11/nylon 11, PA 12/nylon 12, PA 6/nylon 6, PA 8/nylon 8, PA 9/nylon 9, PA 66/nylon 66, PA 612/nylon 612, PA 812/nylon 812, PA 912/nylon 912, etc.). Other examples of crystalline or semi-crystalline polymers suitable for use as the printing material include polyethylene, polypropylene, and polyoxomethylene (i.e., polyacetals). Still other examples of suitable polymeric printing materials include polystyrene, polycarbonate, polyester, polyurethanes, other engineering plastics, and blends of any two or more of the polymers listed herein. Core shell polymer particles of these materials may also be used.

Other examples of the printing material include ceramic particles. Examples of suitable ceramic particles include oxides, carbides, and nitrides. Some specific examples include alumina (Al₂O₃), glass, silicon mononitride (SiN), silicon dioxide (SiO₂), zirconia (ZrO₂), titanium dioxide (TiO₂), or combinations thereof. As an example, 30 wt % glass may be mixed with 70 wt % alumina.

Examples of the metal printing material include copper (Cu), zinc (Zn), niobium (Nb), tantalum (Ta), silver (Ag), gold (Au), platinum (Pt), palladium (Pd), indium (In), bismuth (Bi), tin (Sn), lead (Pb), gallium (Ga), and alloys thereof. While more costly, osmium (Os), rhodium (Rh), ruthenium (Ru), and iridium (Ir) may also be used.

In some examples, composite printing materials may include mixtures of polymer particles and inorganic particles. As examples, any of the previously listed polymer particles may be combined with any of the previously listed ceramic particles to form the composite printing material.

In some examples, the printing material may have a melting or softening point ranging from about 50° C. to about 4000° C. As examples, ceramic particles having a melting point ranging from about 600° C. to about 4000° C. may be used, metal particles having a melting point ranging from about 200° C. to about 3500° C. may be used, or polymers having a melting or softening point ranging from about 75° C. to about 400° C. may be used.

The printing material may be made up of similarly sized particles or differently sized particles. The term “size” or “particle size” is used herein to describe at least the printing material. In some examples, the size or particle size generally refers to the diameter or average diameter, which may vary, depending upon the morphology of the individual particle. In an example, the respective particle may have a morphology that is substantially spherical. A substantially spherical particle (i.e., spherical or near-spherical) has a sphericity of >0.84. Thus, any individual particles having a sphericity of <0.84 are considered non-spherical (irregularly shaped). The particle size of the substantially spherical particle may be provided by its largest diameter, and the particle size of a non-spherical particle may be provided by its average diameter (i.e., the average of multiple dimensions across the particle) or by an effective diameter, which is the diameter of a sphere with the same mass and density as the non-spherical particle.

In some examples, the average size of the particles of the printing material ranges from about 0.01 μm to about 500 μm. In some examples, the polymeric and/or metal printing material may have a particle size ranging from about 5 μm to less than 200 μm. In some examples, a ceramic printing material may have a particle size ranging from about 0.05 μm to about 100 μm.

In some examples, a printing material may comprise fibers. These fibers may for example be formed by cutting extruded fibers into short lengths. For examples, a fiber length may be selected to allow effective spreading of the printing material onto a platen or build platform. For example, the length may be approximately equal to the diameter of the fibers. In some instances, the fibers may have a size or average size on the order of the above-described particles. In some examples, the fibers may sometimes be referred to as a non-spherical particle.

It is to be understood that printing material may include, in addition to the polymer, ceramic, metal or composite particles, a charging agent, a flow aid, or combinations thereof. Charging agent(s) may be added to suppress tribo-charging. Flow aid(s) may be added to enhance the coating flowability of the printing material. In an example, each of the charging agent and/or the flow aid may be added in an amount ranging from greater than 0 wt % to less than 5 wt % based upon the total wt % of the printing material used.

In some examples, the fluid dispenser 426 shown in FIG. 8 comprises a printing mechanism, which comprises an array of printheads, each including a plurality of individually addressable nozzles for selectively ejecting fluid agents onto a layer of printing material. Accordingly, in some examples, the fluid dispenser 426 may sometimes be referred to as an addressable fluid ejection array. In some examples, the fluid dispenser 426 may eject individual droplets having a volume on the order of ones of picoliters or on the order of ones of nanoliters.

In some examples, fluid dispenser 426 comprises a thermal inkjet (TIJ) array. In some examples, fluid dispenser 426 may comprise a piezoelectric inkjet (PIJ) array or other technologies such as aerosol jetting, anyone of which can precisely, selectively deposit a small volume of fluid. In some examples, fluid dispenser 426 may comprise continuous inkjet technology.

In some examples, the fluid dispenser 426 may selectively dispense droplets to yield a voxel level resolution. In one sense a voxel may be understood as a unit of volume in a three-dimensional space. In some examples, a resolution of 1200 voxels per inch in the x-y plane may be implemented via fluid dispenser 426. In some examples, a voxel may have a height (or thickness) of about 100 microns, although a height of the voxel may fall between about 80 microns and 100 microns. However, in some examples, a height of a voxel may fall outside the range of about 80 to about 100 microns.

In some examples, fluid dispenser 426 may comprise, or be in fluid communication with, an array of reservoirs to contain various fluid agents. In some examples, at least some of the fluid agents may comprise a fusing agent, detailing agent, etc. to enhance formation of each layer of printing material. In particular, upon application onto the printing material at selectable positions via the dispenser 426, the respective fusing agent and/or detailing agent may diffuse, saturate, and/or blend into the respective layer of the printing material at the selectable positions.

In some examples the 3D printer 400 comprises at least one energy source for irradiating the deposited printing materials, fluid agents (e.g. fusing agent), etc. to cause heating of the material, which in turn results in the fusing of particles of the material relative to each other, with such fusing occurring via melting, sintering, etc. After such fusing, a layer of printing material is completely formed and additional layers of printing material may be formed in a similar manner.

In some examples the 3D printer 400 can be used to additively form a 3D object via a thermal fusing using a fusing agent and energy source. In some examples, an additive manufacturing process performed via 3D printer 400 may omit at least some aspects of and/or may include at least some aspects of: selective laser sintering (SLS); selective laser melting (SLM); and 3D binder printing (e.g. 3D binder jetting).

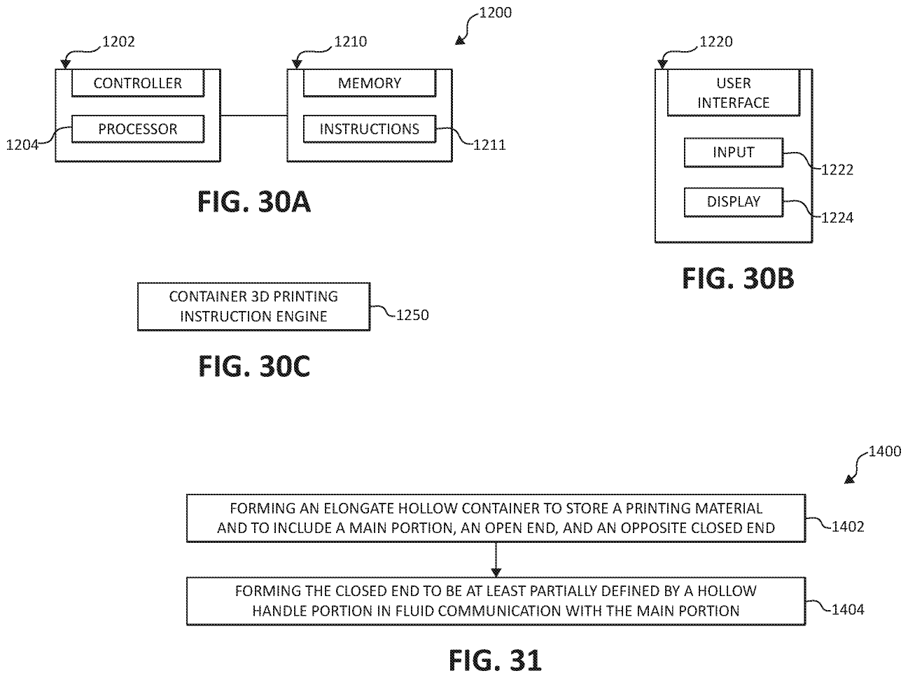

In some examples, 3D printer 400 may comprise and/or be in communication with a control portion to at least partially control operations of 3D printer. One such example control portion 1200 is further described later in association with at least FIG. 30A.

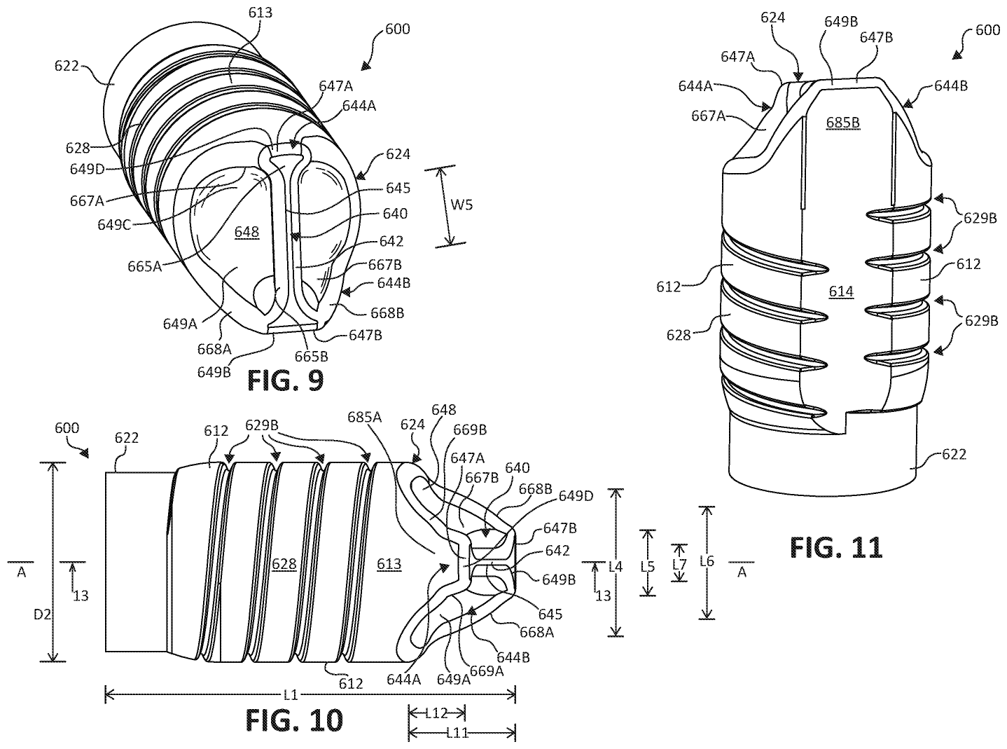

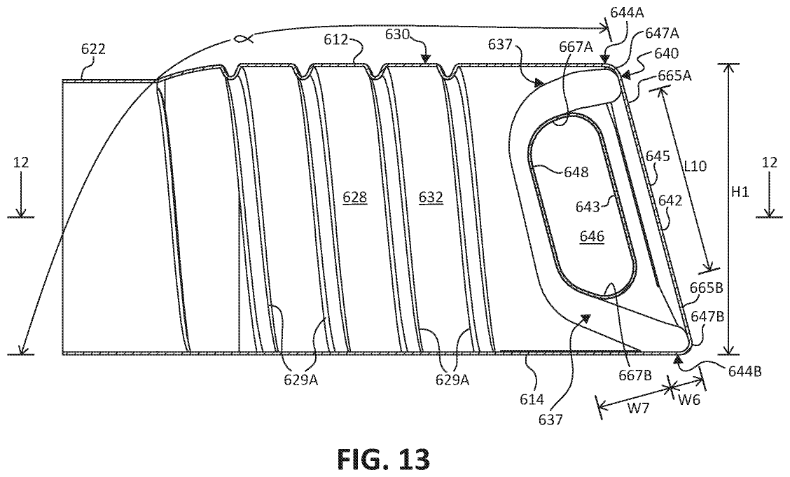

FIGS. 9-13 provide different views, which together schematically represent an example container 600. In some examples, container 600 may comprise at least some of substantially the same features and attributes as at least container 200 as previously described in association with at least FIGS. 4A-7, except with having differently sized and shaped transition portions 644A, 644B, among other differences. In some examples, like container 200 (FIG. 4A-4C), main portion 630 of container 600 comprises an outer side wall 628 comprising a top portion 613, opposite side portions 612, and generally planar bottom portion 614, with side wall 628 also comprising grooves 629B, which correspond to inner ribs 629A (FIG. 13). Container 600 also comprises an openable end 622 and opposite closed end 624.

Like handle portion 240 of container 200, in at least some examples the handle portion 640 at closed end 624 of container 600 comprises a hollow element in fluid communication with an interior 632 of the main portion 630 of container 600 (e.g. FIG. 13). As further shown in FIG. 13, the transition portions 644A, 644B of handle portion 640 may also comprise hollow elements which comprise a respective pair of spaced apart openings 637 on opposite ends of an end wall 648 and through which the elongate segment 642 is in fluid communication with the interior 632 of the main portion 630. As also shown in FIG. 13, in a manner similar to container 200, container 600 comprises a handle portion 640 having an elongate segment 642, which forms an angle α relative to generally planar portion 614.

As shown in FIGS. 9-10 and 12, in some examples a lower transition portion 644B of handle portion 640 may form a generally trapezoidal shape having outer side edge portions 668A, 668B which are relatively straight, at least in comparison to the arcuate outer edge portions 268A, 268B of the lower transition portion 244B in FIGS. 4A-7. However, in some examples, the outer side edge portions 668A, 668B may comprise an at least partially arcuate shape.

As shown in FIGS. 9-11, the lower transition portion 644B comprises a first base 649A and an opposite second base 649B. The first base 649A extends from and is connected to an end wall 648 of the main portion 630. In some instances, the connection between the first base 649A (of the lower transition portion 644B) and end wall 648 may sometimes be referred to as a junction. As shown in at least FIGS. 9 and 13, in some examples the opposite second base 649B of the lower transition portion 644B is connected to and extends from a second end 665B of the elongate segment 642 of the handle portion 640.

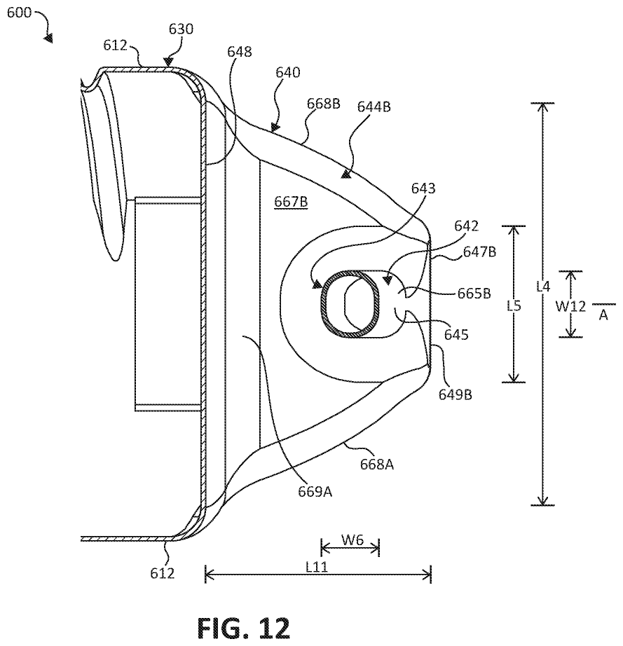

As shown in at least FIGS. 9 and 12, in some examples the first base 649A of lower transition portion 644B has a length L4 substantially greater than a length L5 of the second base 649B of lower transition portion 644B. In some examples in this context, a substantially greater difference may correspond to the length L4 of the first base 649A being 50%, 100%, 150%, 200%, etc. greater than the length L5 of the opposite second base 649B.

In addition, in some examples an upper transition portion 644A of handle portion 640 may form a generally trapezoidal shape having outer side edge portions 669A, 669B which are relatively straight, at least in comparison to the arcuate outer side portions 269A, 269B of the upper transition portion 244A in FIGS. 4A-7. However, in some examples, the outer side edge portions 669A, 669B may comprise an at least partially arcuate shape. In addition, the upper transition portion 644A comprises a first base 649C and an opposite second base 649D.

The first base 649C extends from and connected to an end wall 648 of the main portion 630. In some instances, the connection between the first base 649C (of the upper transition portion 644A) and end wall 648 may sometimes be referred to as a junction. In some examples, the opposite second base 649D of the upper transition portion 644A is connected to and extends from a second end 665A of the elongate segment 642 of the handle portion 640.

In some examples, the first base 649C of the upper transition portion 644A has a length L6 substantially greater than a length L7 of the second base 649D of the upper transition portion 644A. In some examples, in at least this context substantially greater may correspond to a 50%, 100%, 150%, 200% difference between the respective lengths.

In some examples, the second base 649B (e.g. opposite short base) of the lower transition portion 644B has a length L5 substantially greater than the length L7 of the second base 649D (e.g. opposite short base) of the upper transition portion 644A. In some examples, in at least this context the term substantially greater may correspond to a 50%, 100%, 150%, or 200% difference between the respective lengths.

In some examples, as shown in at least FIG. 10, the lower transition portion 644B has a length L11 extending between first base 649A and second base 649B which is substantially greater than a length L12 between first base 649C and second base 649D of upper transition portion 644A. At least in part, this arrangement provides the forward slant of elongate segment 642 to extend at the above-described acute angle α of between about 65 to 85 degrees relative to longitudinal axis A of at least main portion 630 of container 600, as shown in at least FIG. 13.

As further shown in FIG. 9, the handle portion 640 comprises a first outer corner portion 647A and an opposite outer corner portion 647B. The first outer corner portion 647A is defined by a junction between a back surface 645 of elongate segment 642 of handle portion 640 and a second base 649D of upper transition portion 644A.

Meanwhile, the second outer corner portion 647B is defined by a junction between a back surface 645 of elongate segment 642 of handle portion 640 and second base 649B of lower transition portion 644B.

In some examples, the second outer corner 647B defines an utmost end of the container 600 while the first outer corner 647A is in a position interposed between the utmost end of the container 600 (at second outer corner 647B) and the openable end 622 of the container 600. In some examples, this angled handle portion 640 may sometimes be referred to as having a forward slant. In this configuration, a user facing the closed end 624 of the container 600 (e.g. an end view) may view the first outer corner 647A as being farther away from the user than the second outer corner 647B.

In some examples, the top side (e.g. 613 in FIGS. 9-10) of the container corresponding to first outer corner portion 647A may sometimes be referred to as a short side of the container 600 while the opposite, bottom side (e.g. 614) may sometimes be referred to as a long side of the container 600. Accordingly, the container 600 may sometimes be referred to as being asymmetric at least to the extent that the top side of the container is shorter than a bottom side of the container 600.

As further shown in FIG. 9, in some examples a second end 665B of the elongate segment 642 extends from, and is connected to, an upper surface portion 667B of the lower transition portion 644B. Similarly, in some examples an opposite first end 665A of the elongate segment 642 extends from, and is connected to, a lower surface portion 667A of the upper transition portion 644A.

In some examples, at least some of the above-described dimensional and/or geometrical differences between the upper transition portion 644A and the lower transition portion 644B may result in the lower transition portion 644B defining a storage volume which is substantially greater than a storage volume of the upper transition portion 644A. In some examples, in at least this context a substantially greater difference corresponds to a difference of 2×, 3×, 4×, etc.

In some examples, as shown in at least FIGS. 10-11, the substantially greater volume of the lower transition portion 644B also corresponds with an exterior, bottom surface 685B of the lower transition portion 644B (FIG. 11) of the handle portion 640 defining an external surface area which is substantially greater than an external surface area of an exterior top surface 685A of the upper transition portion 644A (FIG. 10). In one aspect, this arrangement may contribute to the stability of the container 600 when in storage on a shelf and/or when removably inserted within a receiving portion (e.g. slot 280) of a material supply of a 3D printer (FIGS. 6-7). In some examples, at least a portion of the exterior, bottom surface 685B of the lower transition portion 644B extends contiguously with, and/or blends together with, the generally planar bottom portion 614 of outer side wall 628 of main portion 630 of container 600, as shown in FIG. 11. In some instances, the exterior, bottom surface 685B of lower transition portion 644B of handle portion 640 also may considered an extension of the generally planar bottom portion 614.

With reference to at least FIGS. 12-13, in some examples the openings 637 defined by each transition portion 644A, 644B (FIG. 13) may comprise a minimum inner cross-sectional area (e.g. hollow area) which is substantially greater than a particle size of the printing material to be stored within container 600. In some examples, in this context the substantially greater difference corresponds to a difference of at least one order of magnitude, at least two orders of magnitude, etc.

As shown in FIGS. 9-10 and 12-13, in some examples, the elongate segment 642 of handle portion 640 comprises a cross-sectional shape having at least some of substantially the same features and attributes as the cross-sectional shape shown in FIG. 5A for the examples handle portion 240. However, as previously described in association with at least FIGS. 4A-5B and FIG. 3, the elongate segment 642 may comprise other cross-sectional shapes.

As further shown in the view of FIG. 12-13, the elongate segment 642 of handle portion 640 has a width W6 (extending between first surface 643 and back surface 645) while the handle portion 640 at least partially defines a void 646 (like void 246 in FIGS. 4A-4C), which has a width W7.

As shown in FIG. 13, a length L10 of void 646 between inner surfaces 667A, 667B of the respective opposite transitions portions 644A, 644B comprises between about 70 percent and 90 percent of a greatest cross-sectional dimension of the main portion 630 of container 600, such as a diameter (D2 in FIG. 10) or a height H1. In some examples, this length L10 is at least 80 percent of the greatest cross-sectional dimension of the main portion 630 of container 600. In some examples, this length L10 may facilitate the above-described full-gripping of segment 642 in which all four fingers may be wrapped about elongate segment 642 of handle portion 640 with the fingers extending within and/or through the void 646.

As shown in at least FIG. 9, in some examples, the end wall 648 comprises a width W5 at least about 50% of the greatest cross-sectional dimension of the main portion 630 of container 600, such as an outer diameter D2 (FIG. 10) or height H1. In some examples, the generally planar end wall 248 extends in a plane generally parallel to a longitudinal axis (C) of the elongate segment 642 of handle portion 640. Accordingly, in some such examples, the end wall 648 also defines the same acute angle α (as elongate segment 642) relative to the generally planar portion 614 of container 600.

However, in some examples, the end wall 648 extends in a plane generally perpendicular relative to the generally planar portion 614 and relative to a longitudinal axis A of container 600.

As shown in at least FIG. 10, in some examples, the handle portion 640 (including the transitions portions 644A, 644B) comprises a length L11, which is about 20 to 25 percent of the overall length L1 of the container 600. In some examples, the handle portion 640 (including the transition portions 644A, 644B) may be between about 5 to 10 percent of the overall volume (e.g. 10 liters) available to carry a printing material within container 600.

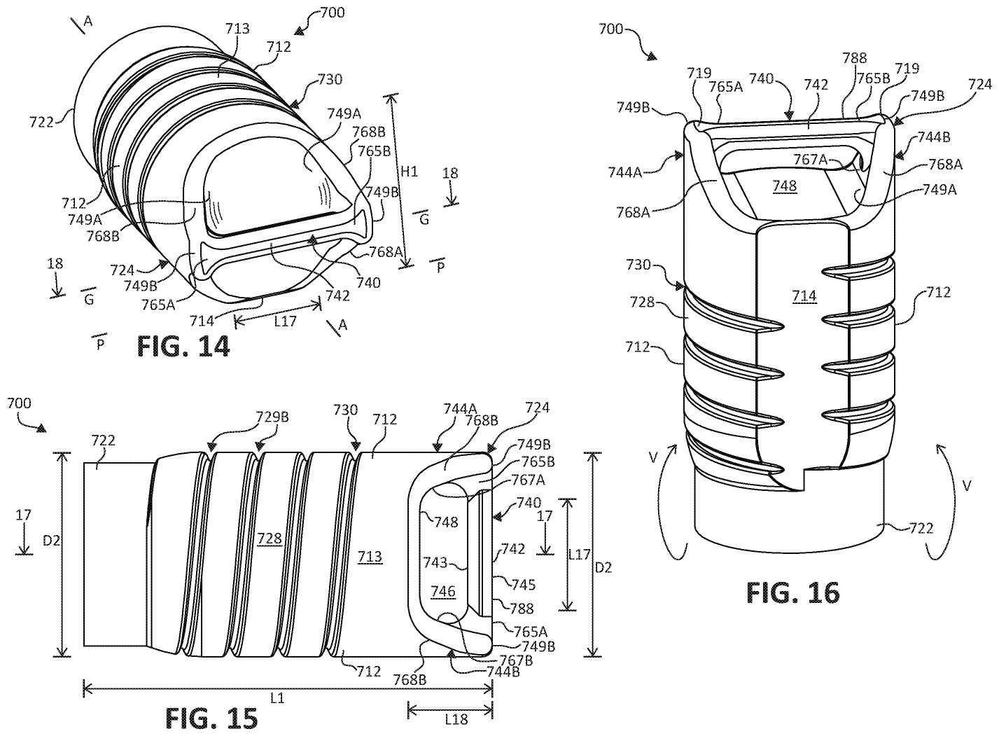

FIGS. 14-18 provide different views schematically representing an example container 700. In some examples, container 700 may comprise at least some of substantially the same features and attributes as containers 200, 600 as previously described in association with at least FIGS. 4A-7, 9-13, except with container 700 having a handle portion 740 having a different orientation relative to a generally planar portion 714, among some other differences. In some examples, like container 200 (FIG. 4A-4C), main portion 730 of container 700 comprises an outer side wall 728 comprising a top portion 713, opposite side portions 712, and generally planar bottom portion 714, with side wall 728 also comprising grooves 729B, which correspond to inner ribs 729A (FIG. 18). Container 700 also comprises an openable end 722 and opposite closed end 724.

As in the previously described examples, the handle portion 740 at closed end 724 of container 700 is hollow to store a printing material and is in fluid communication with the main portion 730 to permit the printing material to flow readily between the handle portion 740 and the main portion 730. For instance, as shown in at least FIG. 14, handle portion 740 comprises an elongate segment 742 having a longitudinal axis G which extends generally parallel relative to a plane P through which the generally planar portion 714 extends. In one aspect, the longitudinal axis G of the elongate segment 742 extends generally perpendicular to a longitudinal axis A of the main portion 730 of container 700. In doing so, the elongate segment 742 of handle portion 740 does not provide an angled grip (relative to generally planar portion 714) as in the containers 200 (FIGS. 4A-7), 600 (FIGS. 9-13). In addition, the handle portion 740 extends in an orientation rotated 90 degrees relative to the generally planar bottom portion 714, as compared to the example containers 200, 600. However, like the container 600 in FIGS. 9-13, in some examples a longitudinal axis G of the elongate segment 742 extends generally parallel to a plane through end wall 748 extends.

As shown in FIGS. 14-16, the handle portion 740 comprises a pair of opposite transition portions 744A, 744B which generally have the same size and shape such that they are generally symmetric relative to each other. As in the container 600, the respective transition portions 744A, 744B comprise a respective pair of spaced apart openings 737 (FIG. 18) on opposite ends of the end wall 748 and through which the elongate segment 742 is in fluid communication with the interior 732 of the main portion 730.

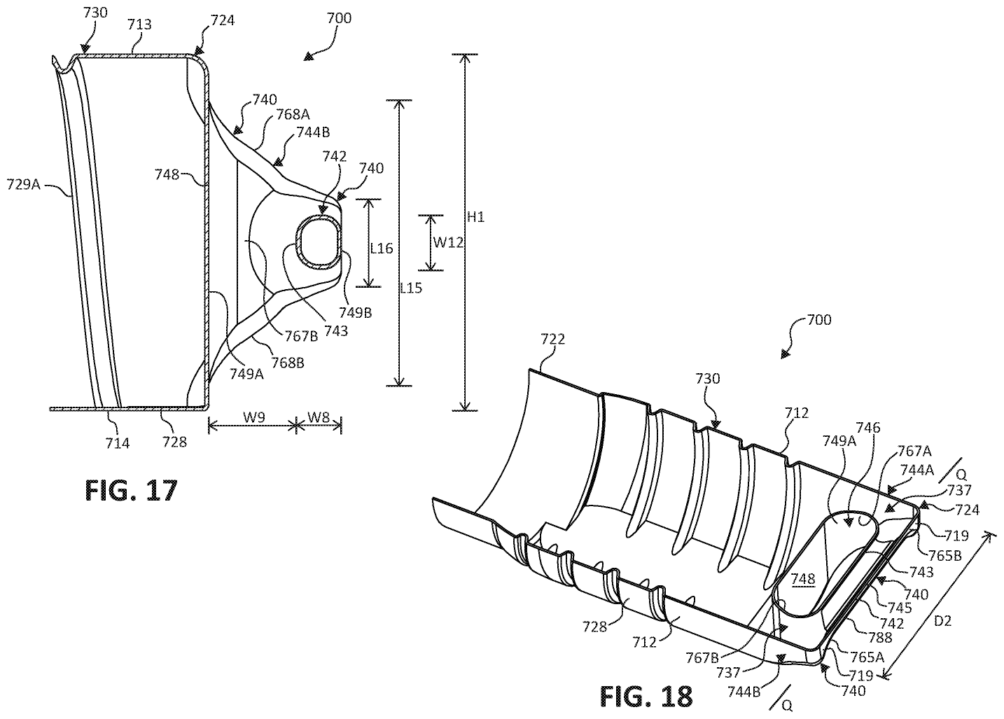

In some examples, as shown in at least FIGS. 14-17, both of the transition portions 744A, 744B correspond to a generally trapezoidal shape in which a first base 749A (FIG. 14) of each respective transition portion 744A, 744B extends from, and is connected to the end wall 748. As shown in at least FIGS. 14 and 17, in this arrangement an opposite second base 749B of each respective transition portion 744A, 744B extends from, and is connected to, one of two opposite ends 765A, 765B of the elongate segment 742. However, as shown in FIGS. 14-16, in some examples in both transition portions 744A, 744B, the respective opposite side edges 768A, 768B of the respective general trapezoidal shape may have a slight arcuate shape.

As shown in at least FIG. 17, in a manner substantially the same as in container 600, in some examples of container 700 the first base 749A of each respective transition portion 744A, 744B comprises a length L15 which is substantially greater than a length L16 of the opposite second base 749B of each respective transition portion 744A, 744B. In some examples, in this context the term substantially greater corresponds to a difference of 2×, 3×, 4×, etc.

As further shown in FIG. 17, in a manner substantially the same as in container 600, in some examples a diameter W8 of the inner cross-sectional area 765 (or a greatest cross-sectional dimension) of the elongate segment 742 is substantially greater than a particle size of the printing material. It will be understood that in at least some examples, the term diameter may refer to an average diameter or a maximum diameter.

As shown in at least FIGS. 15-16 and 18, in some examples the elongate segment 742 comprises a back surface 745 which may define an utmost end 788 of the entire container 700. As shown in FIGS. 14-18, in some examples the back surface 745 may extend in generally the same plane (Q) as an utmost end 719 of opposite side portions 712 of outer side wall 728 of the container 700. However, in some examples, back surface 745 of elongate segment 742 of handle portion 740 may be recessed relative to the utmost end 719 of the respective side portions 712 of the container 700.

As shown in FIG. 17, in a manner substantially the same as in container 600, in some examples the void 746 defined between the end wall 748 and the inner surface 743 of the elongate segment 742 of handle portion 740 has a width W9 substantially greater than a distance or diameter W8 (extending between front surface 743 and back surface 745) of the elongate segment 742. In some examples, in at least this context, a substantially greater difference corresponds to at least a 2×, 3×, greater difference. In some examples, the elongate segment 842 may comprise a width W12 which is the same as or greater than the distance W8.

As shown in at least FIGS. 14 and 17, in some examples the end wall 748 comprises a height H1 extending between the generally planar bottom portion 714 and the top surface portion 713 of main portion 730 of container 700. In some examples, height H1 may be about 80 to 95 percent of the outer diameter D2 of main portion 730 of container 700 (FIG. 17) or other greatest cross-sectional dimension. In some examples, height H1 may be about 90 percent of the diameter D2.

As shown in FIGS. 14-15, a length L17 of void 746 between inner surfaces 767A, 767B of the respective opposite transitions portions 744A, 744B comprises between about 70 percent and 90 percent of a diameter D2 of the main portion 730 of container 700. In some examples, this length L17 is at least 80 percent of the diameter D2. In some examples, this distance may facilitate the above-described full-gripping of segment 742 in which all four fingers may be wrapped about elongate segment 742 of handle portion 740 with the fingers extending within and/or through the void 746.

In one aspect, the orientation of the elongate segment 742 being generally parallel to the general planar portion 714 may facilitate handling of container 700 during loading to ensure a correct orientation of insertion of container 700 into a receiving portion (e.g. slot 280) of a material supply of a 3D printer (FIGS. 6-7). In particular, this particular orientation of handle portion 740 provides a one hand-gripping preference for at least some users in which a supinated grip of elongate segment 742 may ease manually raising (as represented via rotational arrow V) the main portion 730 of the container 700 from a vertical orientation (e.g. FIG. 16) to a horizontal orientation (e.g. FIG. 14). In some examples, a second hand may support the main portion 730 of container 700 during such rotation of container 700. In some such examples, a thumb (of the hand gripping elongate segment 742) may at least partially wrap about the elongate segment 742 instead of the thumb pressing against a back surface 745. Such selective rotation of container 700 may facilitate positioning the container 700 for placement onto a storage shelf and/or for slidable insertion into a receiving portion (e.g. slot 280 in FIGS. 6-7) of a material supply of a 3D printer (FIG. 8).

Meanwhile, this particular orientation of the elongate segment 742 of the handle portion 740 also may facilitate carrying the container 700 in one of several different orientations, such as a neutral hand grip (in which the palm faces the side of the body), a pronated hand grip (in which the palm faces backward), or a supinated hand grip (in which the palm faces forward).

As further shown in the sectional view of FIG. 17, in some examples the elongate segment 742 of handle portion 740 comprises a generally rounded-rectangular cross-sectional shape, although other cross-sectional shapes as previously described in association with at least FIGS. 5A-5B, 3 may be employed instead.

As shown in at least FIG. 15, in some examples, the handle portion 740 (including the transitions portions 744A, 744B) comprises a length L18, which may be about 15 to 25 percent of the overall length L1 of the container 700. In some examples, the handle portion 740 (including the transition portions 744A, 744B) may be between about 5 to 10 percent of the overall volume (e.g. about 10 Liters) available to carry a printing material within container 700. However, in some examples, the container 700 may provide a greater volume-bearing capacity for the same overall length L1 and diameter D2 as containers 200, 600 at least because a longitudinal axis G (FIG. 14) of elongate segment 742 of handle portion 740 extends in a plane generally perpendicular to the generally planar bottom portion 714 and does not extend in an angled position like in the containers 200, 600. Moreover, via this arrangement, an increased interior volume may be implemented at least partially because the end wall 748 may be positioned slightly farther away from openable end 722 because the respective transition portions 744A, 744B are symmetrically sized and shaped relative to each other.

FIGS. 19-23B provide different views schematically representing an example container 800. In some examples, container 800 comprises at least some of substantially the same features and attributes as the containers 20, 200, 600, 700 as previously described in association with at least FIGS. 1-7 and 9-18.

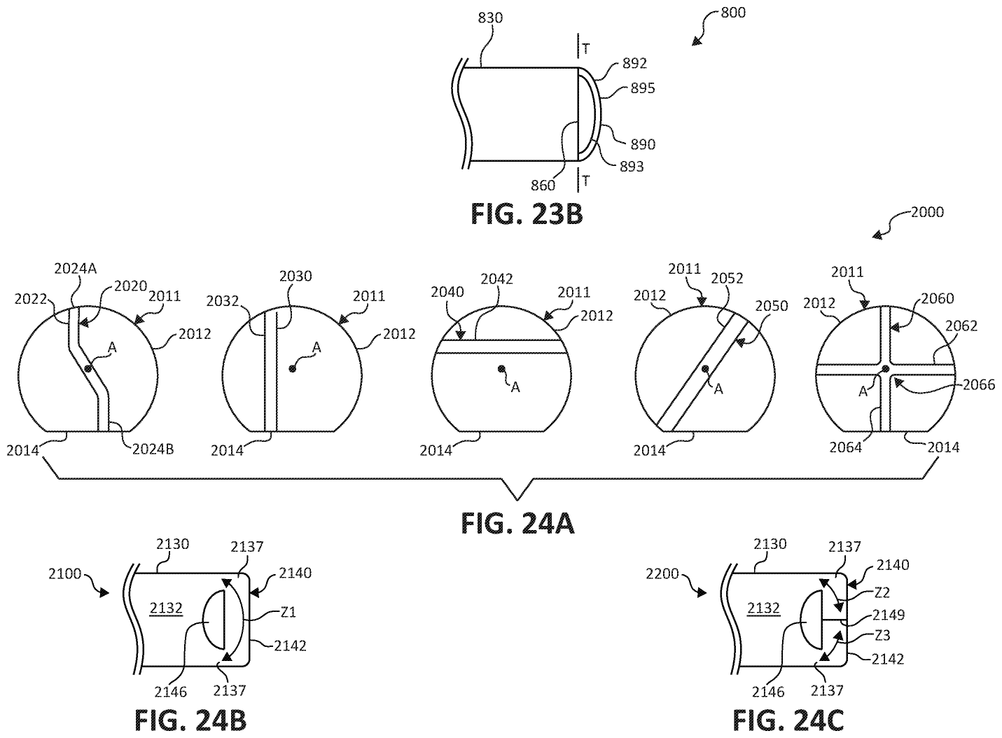

As shown in FIG. 19, example container 800 comprises an elongate shell 801 to store a printing material, with the shell 801 including an openable end 822 and an opposite closed end 824. In some examples, the elongate shell of container 800 comprises a main portion 830 comprising at least some of substantially the same features as the previously described main portions 230, 630, 730, etc. In some examples, like container 200 (FIG. 4A-4C), main portion 830 of container 800 comprises an outer side wall 828 comprising a top portion 813, opposite side portions 812, and generally planar bottom portion 814, with side wall 828 also comprising grooves 829B, which correspond to inner ribs 829A (FIG. 23A). Container 800 also comprises an openable end 822 and opposite closed end 824.

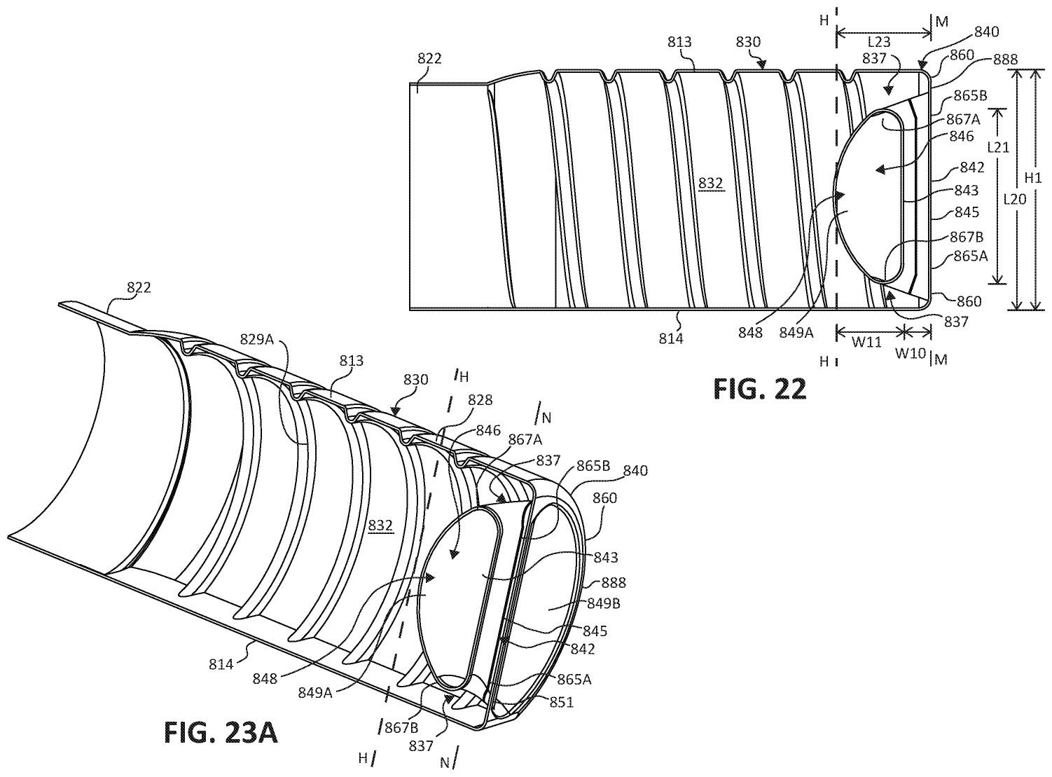

As shown in FIGS. 19, 21-23A the closed end 824 of container 800 comprises a recessed end wall 848 and an elongate hollow handle portion 840 spaced apart from the recessed end wall 848 to define a void 846 between the handle portion 840 and the end wall 848. As in at least some examples of the previously-described containers, the handle portion 840 is in fluid communication with an interior 832 of the shell as shown in at least FIGS. 22-23.

As shown in FIGS. 19-23B, in some examples the recessed end wall 848 comprises a generally concave arcuate surface including a vertex 849A and an inner side wall 849B. In some examples, the arcuate surface of recessed end wall 848 may comprise a bowl-shaped wall or a generally hemi-spherically shaped wall. However, in some examples, at least a portion of the recessed end wall 848, such as a region adjacent the vertex 849A, may comprise a planar portion or other non-arcuate shapes.

In some examples, opposite ends 865A, 865B of the elongate segment 842 of handle portion 840 are connected to, and extend from, respectively opposite sides (e.g. surfaces 867A, 867B in FIG. 22) of the inner side wall 849B. As shown in FIGS. 22, 23A, in some examples the opposite ends 865A, 865B comprise a respective pair of spaced apart openings 837 on opposite ends of the recessed end wall 848 and through which the elongate segment 842 of handle portion 840 is in fluid communication with the interior 832 of the main portion 830. In some examples, at least one or both of openings 837 may comprise a cross-sectional area which is generally equal to or greater than a cross-sectional area of the elongate segment 842 to promote flowability of printing material from the elongate segment 842 into the main portion 830.

Via this arrangement, the elongate segment 842 of handle portion 840 extends across the bowl-shaped recess defined by end wall 848.

Accordingly, in some examples, at least the elongate segment 842 of handle portion 840 may be viewed as being surrounded in a 360 degree panorama by inner side wall 849B of the recessed end wall 848. Via this arrangement, a full-fingered grip may be taken about elongate segment 842 as the user's fingers may extend into, and may curl within the bowl-shaped end wall 848 to facilitate gripping the elongate segment 842.

As shown in FIG. 19, in some examples a longitudinal axis N of elongate segment 842 of the hollow handle portion 840 extends generally perpendicular to a longitudinal axis A of the main portion 830 of container 800. As shown in FIGS. 22-23A, elongate segment 842 of handle portion 840 comprises a first surface 843 (e.g. front surface) and an opposite second surface (e.g. back surface) 845. The first surface 843 is spaced apart from, and faces, the end wall 848. Meanwhile, the second surface 845 faces away from the container 800. As shown in FIG. 21, in some examples the second surface 845 of elongate segment 842 of handle portion 840 extends in generally the same plane M as an end surface 860 of an outer side wall 828 of the container 800. The second surface 845 sometimes may be referred to as a back surface 845. In some examples, the end surface 860 of the outer side wall 828 may sometimes be referred to as comprising a generally circular shape, with the exception of the region corresponding to generally planar bottom portion 814.

In some examples, the end surface 860 and the back surface 845 both define an utmost end 888 of the container 800. However, it will be understood that in some examples at least a portion of the elongate segment 842 (including back surface 845) may be recessed relative to end surface 860 of the outer side wall 812.

In some examples, the inner side wall 849B of recessed end wall 848 and the outer side wall 828 extend toward each other such that inner side wall 849B and outer side wall 828 are connected together to form a junction at utmost end 888 of container 800. In some examples, this junction may sometimes be referred to as a rim.

As shown in the partial side view of FIG. 23B, in some examples a hollow handle portion 890 comprises an elongate segment 892 (including back surface 895), which protrudes outwardly relative to end surface 860 of the outer side wall 828. In some such examples, at least the back surface 895 may include at least a portion comprising a convex shape facing away from the container 800 and/or the inner surface 893 of elongate segment 892 may comprise a concave shape spaced apart from a plane M through which the end surface 860 of the outer side wall 812 extends. It will be understood that in at least this example, the end wall 848 may retain its recessed shape. In some examples, this arrangement may enhance full-finger access to, and gripping of, the elongate segment 892 of handle portion 890.

As shown in at least FIG. 22-23, the elongate segment 842 of handle portion 840 comprises a generally rounded-rectangular cross-sectional shape. However, in some examples, the elongate segment 842 may have a different cross-sectional shape, such as one of the cross-sectional shapes as previously described in association with at least FIGS. 5A-5B, 3. In some examples, the opposite ends 865A, 865B of handle portion 840 each are connected to and extend from a surface portion 851 of the inner side wall 849B of the recessed end wall 848 such that the elongate segment 842 may be in fluid communication with an interior of the main portion 830. However, it will be understood that in some examples, a connection region between the outer side wall 828 and each respective ends 865A, 865B of the elongate segment 842 of handle portion 840 also may at least partially define the utmost end 888 of the container and utmost end 860 of the outer side wall 828.

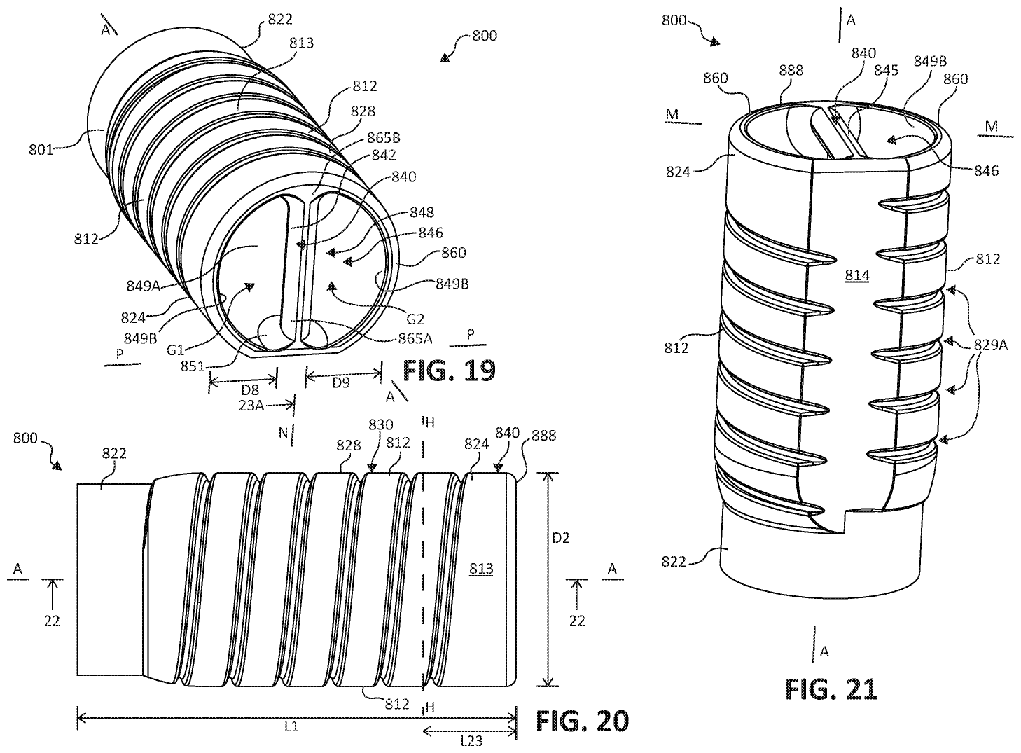

As shown in FIGS. 20 and 22, in some examples at least the back surface 845 of the elongate segment 842 of handle portion 840 may comprise a length L20 generally corresponding to height H1 (FIG. 22) of the main portion 830.

In some examples, alignment of elongate segment 842 of handle portion 840 to be generally perpendicular relative to generally planar portion 814 may facilitate correct orientation of at least main portion 830 of container 800 during slidable insertion of container 800 into a receiving portion (e.g. slot 280) of a material supply of a 3D printer (FIGS. 6-8). In some examples, this handle configuration facilitates the correct orientation by promoting a neutral hand grip (e.g. palm facing a side of the body) during such insertion and/or during carrying such that the container 800 may be readily pivoted between a vertical orientation (FIG. 21) and a horizontal orientation (FIG. 19).

As shown in at least FIG. 22, in a manner substantially the same as in at least containers 600, 700, in some examples the void 846 defined between the vertex 849A of end wall 848 and the front surface 843 of the elongate segment 842 of handle portion 840 has a width W11 substantially greater than a greatest cross-sectional dimension W10 of the elongate segment 842. In some examples, in this context, a substantially greater difference means at least a 2×, 3×, greater difference.

As shown in FIG. 22, a maximum length L21 of void 846 between outer surfaces 867A, 867B on opposite sides of the inner side wall 849B of bowl-shaped end wall 848 comprises between about 70 percent and 90 percent of an outer diameter D2 (FIG. 20) or height H1 (FIG. 22) of the main portion 830 of container 800. In some examples, this length L21 is at least 80 percent of the outer diameter D2 or height H1.

In some examples, upon the length L21 being sufficiently large (e.g. on the order of 100 to 130 millimeters) and with the elongate segment 842 bifurcating the bowl-shaped recess, sufficient gaps G1, G2 remain (as shown in FIGS. 19, 22) to provide space for entry of a user's fingers on either side of the elongate segment 842. Via this arrangement, this length L21 may facilitate the above-described full-gripping of segment 842 in which all four fingers may be wrapped about elongate segment 842 of handle portion 840 with the fingers extending within and/or through the void 846. As shown in FIGS. 19 and 22, in some examples each gap G1, G2 may be substantially greater than a greatest cross-sectional dimension or diameter (W10 in FIG. 22) of the elongate segment 842, such as each gap G1, G2 having a width (D8, D9 in FIG. 19) being 2×, 3×, 4×, etc. greater than the greatest cross-section dimension or diameter W10 of the elongate segment 842. In some examples, each gap G1, G2 may be on the order of 70 to 90 millimeters while the greatest cross-sectional dimension W10 may be on the order of 20-30 millimeters.

In some examples, the elongate segment 842 may be located off-center (relative to a central longitudinal axis A of the main portion 830 of the container 800) and the gaps G1, G2 on opposite sides of the elongate segment 842 may have different dimensions such that one gap G1 may be larger than the other gap G2, or vice versa.

In some examples, by extending the entire outer side wall 828 to the utmost end 888 of the container, this arrangement may substantially increase the storage capacity of the container 800 as compared to at least some containers in which the handle portion comprises a loop protruding away from an end wall of the main portion of a container. In some examples, the hollow elongate segment 842 of the handle may extend within a space defined by bowl-shaped end wall 848, which may further contribute to the expanded storage capacity without otherwise extending the length of the container 800.

As shown in at least FIGS. 20, 22 in some examples in which a dashed line H represents a boundary between main portion 830 and handle portion 840 of container 800, the handle portion 840 (including recessed end wall 848) may comprise a length L23, which is about 20 to 25 percent of the overall length L1 of the container 800. In some such examples, the handle portion 840 (including volume at least partially defined by the recessed end wall 848) may be between about 10 to about 15 percent of the overall volume (e.g. about 11.5 liters) available to carry a printing material within container 800.

In some examples, container 800 may provide a substantially increased volume (e.g. about 11.5 liters) for generally the same length L1 and diameter D2 as one of the other example containers (e.g. 200 in FIGS. 4A-5A), which generally may have a volume on the order of 10 liters. Accordingly, container 800 may enhance efficiency in operating a 3D printer by reducing the frequency with which a material supply is to be replenished via a consumable printing material container, such as container 800. This, in turn, may reduce overall operating costs, inventory control costs, storage costs, shipping costs, etc. associated with providing a reliable, timely supply of printing material for a 3D printer.

In one aspect, increasing the load-carrying volume while retaining the general dimensions (e.g. outer diameter, and overall length) may permit use of the container 800 in a receiving portion of an existing material supply of a 3D printer without redesigning or remanufacturing the receiving portion of the material supply, as might be indicated if an overall length and/or outer diameter of a container for a material supply were increased.

FIG. 24A is a diagram schematically representing an array 2000 of example handle portions for a container 2011 with the respective handle portion having different rotational orientations and/or off-center positions. In some examples, each handle portion of array 2000 may correspond to a modification or substitution for one of the elongate segments of a handle portion of the previously described respective example containers 200, 600, 700, and 800. In general terms, container 2011 comprises an arcuate outer edge portion 2012, a bottom planar edge portion 2014, and one of the example handle portions 2020, 2030, 2040, 2050, and 2060. However, in some examples container 2011 may comprise one of the cross-sectional shapes shown in FIG. 3, and similar shapes.

As shown in FIG. 24A, in some examples handle portion 2020 comprises an elongate segment 2022 comprising at least one curve or bend between its respective ends 2024A, 2024B. In some examples, a center region of the elongate segment 2022 may be aligned with a central longitudinal axis A of the container 2011.

As shown in FIG. 24A, in some examples handle portion 2030 comprises an elongate segment 2032 extending perpendicular to bottom planar edge portion 2014 and aligned off-center relative to a central longitudinal axis A of the container 2011.

As shown in FIG. 24A, in some examples handle portion 2040 comprises an elongate segment 2042 extending generally parallel to bottom planar edge portion 2014 and aligned off-center relative to a central longitudinal axis A of the container 2011.

As shown in FIG. 24A, in some examples handle portion 2050 comprises an elongate segment 2052 extending in a diagonal orientation which is neither generally perpendicular to nor generally parallel to a bottom edge portion 2014. In some examples, a center region of the elongate segment 2052 may be aligned with a central longitudinal axis A of the container 2011.

As shown in FIG. 24A, in some examples handle portion 2060 comprises at least two elongate segments 2062, 2064. In some examples, the at least two elongate segments 2062, 2064 extend generally perpendicular to each other. In some examples, the two elements 2062, 2064 together may form a junction 2066. In some examples, a center region of the respective elongate segments 2062, 2064 may be aligned with a central longitudinal axis A of the container 2011.

At least some of the example handle portions of array 2000 may retain an overall balance of weight during rotation of container 2011 during automated removal of printing material from container 2011 (in cooperation with a material supply of a 3D printer) in view of the elongate elements (e.g. 2022, 2052, 2062, 2064) being aligned with the central longitudinal axis A of the container 2011.

FIGS. 24B-24C are each a partial side sectional view schematically representing an example handle portion of an example container. As shown in FIG. 24B, example container 2100 may comprise at least some of substantially the same features and attributes as one of the previously described containers 20, 200, 600, 700, 800. Accordingly, container 2100 comprises a main portion 2130 and handle portion 2140, which has a grippable elongate segment 2142 spaced apart from an end wall via void 2146. Via openings 2137, material may freely flow between an interior of the main portion 2130 and elongate segment 2142. As represented via arrow Z1, the material may flow through a full length of the elongate segment 2142.

However, as shown in FIG. 24C, in some examples a container 2200 may have similar attributes except for the elongate segment having a wall 2149 or other blocking structure which prevents material from flowing through a full length of the elongate segment 2142. Nevertheless, the material may still flow freely between the interior of the main portion 2130 and the elongate segment 2142 on opposite sides of the wall 2149, as represented via separate arrows Z2 and Z3. In some instances, the elongate segment 2142 of example container 220 may sometimes be referred to as being at least partially hollow to the extent that elongate segment 2142 (and handle portion 2140 generally) are hollow except for the transverse wall 2149.

FIGS. 25A-28 provide different views schematically representing an example container 900, which may comprise a main portion 930 and a handle portion 940. In some examples, container 900 comprises at least some of substantially the same features and attributes as the containers 20, 200, 600, 700, 800 as previously described in association with at least FIGS. 1-7 and 9-23B. For instance, container 900 comprises a main portion 930 having at least some of substantially the same features and attributes as the previously described respective main portions 230, 630, 730, 830. In some examples, like container 200 (FIG. 4A-4C), main portion 930 of container 900 comprises an outer side wall 928 comprising a top portion 913, opposite side portions 912, and generally planar bottom portion 914, with side wall 928 also comprising grooves 929B, which correspond to inner ribs 929A (FIG. 28). Container 900 also comprises an openable end 922 and opposite closed end 924.

While a handle portion 940 of container 900 comprises at least some of substantially the same features and attributes as previously described handle portions 240, 640, 740, 840, handle portion 940 also comprise some differences.

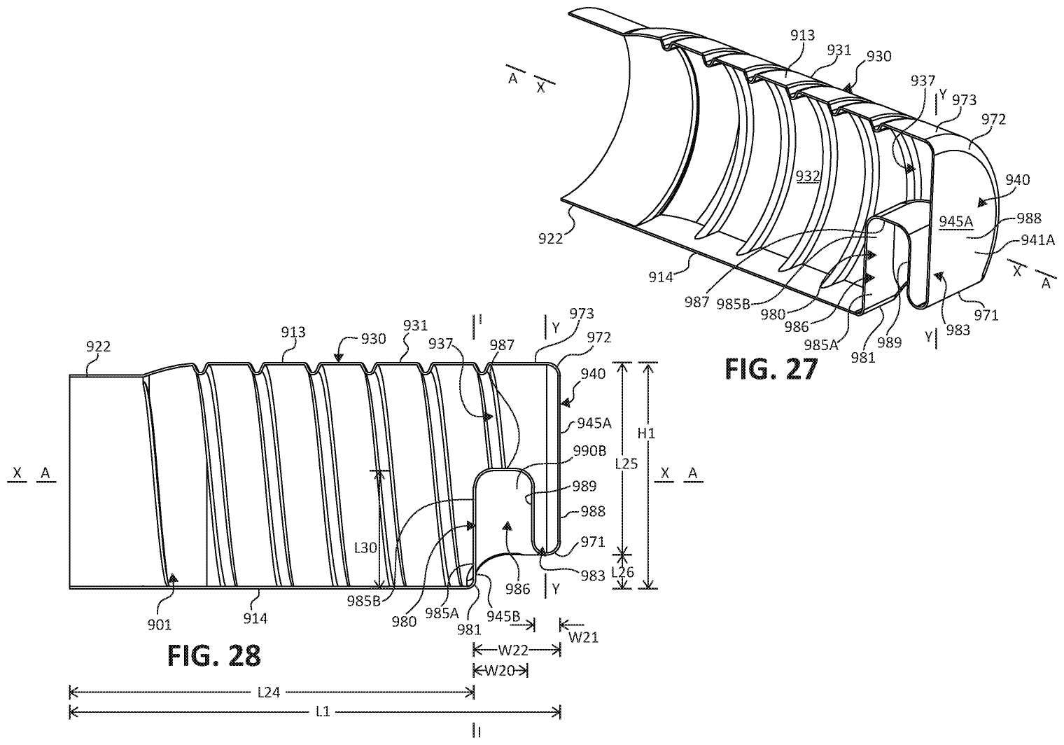

As shown in at least FIGS. 25A and 26A, container 900 comprises an elongate shell 901 or reservoir to store a printing material, and comprises an openable end 922 and an opposite closed end 924. As best seen in the sectional views of FIGS. 27-28, the opposite closed end 924 comprises a hollow handle portion 940 in fluid communication with the main portion 930. As shown in FIGS. 27-28, the container 900 may comprise a single opening 937 to permit the fluid communication between an interior 932 of the main portion 930 and an interior 939 of the handle portion 940. Via grasping handle portion 940, the container 900 is removably insertable into a receiving portion (e.g. slot 280) of a material supply of a 3D printer (FIGS. 6-8) and/or is suitable for carrying. Meanwhile, the hollow handle portion 940 provides for storing higher volumes of printing material within container 900.

In some examples, FIGS. 25A and 25B schematically represent the container 900 in a horizontal orientation, such as during storage and/or upon insertion into the receiving portion as noted above. Meanwhile, in some examples, FIG. 26A schematically represents the container 900 in a vertical orientation, such as during carrying the container 900. Further details regarding use of the handle portion 940 regarding these orientations are provided below.

As best seen in FIGS. 25A-26A, in some examples the handle portion 940 comprises an at least partially disc-shaped body B. In some examples, the disc-shaped body may sometimes be referred to as an at least partially cylindrically shaped body. Among other features and as shown in at least FIG. 26A, the handle portion 940 comprises a finger-grippable flange 983 spaced apart from an end wall 980 of main portion 930. As best seen in FIGS. 26A-28, in some examples a recess 986 is defined between at least a portion of the end wall 980 and the flange 983. In some examples, the recess 986 is also at least partially defined by an inner wall 987 extending between the end wall 980 and the flange 983. In some examples, the recess also may sometimes be referred to as a finger-grippable recess 986, e.g. a recess by which fingers may be used to grasp handle portion 940.

Via this arrangement, in some examples a user may securely grasp handle portion 940 by releasably engaging their fingers of one hand within recess 986 and against flange 983 while using a thumb of the same hand to grip an outer side wall 973 (FIG. 25A) of handle portion 940. As observable via at least FIGS. 27-28, the recess 986 and flange 983 together are generally on an opposite side of the handle portion 940 relative to an outer side wall 973.

With this in mind, further details regarding the structure and relationship of the flange 983, recess 986, and other portions of the handle portion 940 will be described below.

For instance, as shown in at least the end view of FIG. 25B, in some examples the handle portion 940 comprises a first side portion 941A including end surface 945A and a second side portion 941B including end surface 945B. In some examples, a first end surface 945A of first side portion 941A defines an utmost end 988 of the container 900 and the first side portion 941A comprises the flange 983, recess 986, and other structural features as further described below. The first side portion 941A may comprise an arcuate outer edge portion 972 and a straight edge portion 971. However, in some examples, the edge portion 971 may comprise an arcuate edge portion, which may be slightly convex or slightly concave.

In one aspect, the arcuate edge portion 972 of the first side portion 941A forms a periphery of the at least partially disc-shaped body B of the handle portion 940, with the arcuate edge portion 972 corresponding to an at least partially circular shape.

Moreover, as shown in at least FIGS. 25A and 27-28, in some examples the first side portion 941A of handle portion 940 includes an arcuate side wall portion 973 extending from, and substantially contiguous with, an arcuate side wall portion 931 of the main portion 930. In some examples, the arcuate side wall portion 931 of main portion 930 comprises the top portion 913 and both side portions 912 of outer side wall 928 of main portion 930. With this in mind, the outer side wall 973 of handle portion 940 may sometimes be viewed as having an arcuate shape matching, and aligned with, an arcuate shape of at least a portion of the outer side wall 931 of main portion 930 of the container 900. In this way, an exterior contour of the first side portion 941A of the handle portion 940 may have the appearance (size and shape) of the exterior contour of the main portion 930. In addition, extending the outer side wall portion 931 of main portion 930 to form outer side wall portion 973 of handle portion 940 provides one way to maximize storage capacity within the handle portion 940. Accordingly, in some examples, via this extension, the outer side wall portion 931 and the outer side wall portion 973 together form an uninterrupted outer side wall for at least a portion of at least one side of the container 900.

In some examples, the straight edge portion 971 of first side portion 941A corresponds to a transition or boundary between the first side portion 941A and the second side portion 941B. In some examples, the straight edge portion 971 also defines an edge of the previously mentioned flange 983.

Meanwhile, as shown via at least FIGS. 25B-28 the end surface 945B of second side portion 941B is defined by a portion 985A of end wall 980 of main portion 930. The second side portion 941B is spaced apart from (e.g. setback from) end surface 945A of the first side portion 941A in a direction parallel to a longitudinal axis A of the main portion 930. In one aspect, end wall 980 includes an outer straight edge 981 which forms a junction with an end of the bottom flat portion 914 of container 900.

In particular, as shown in at least FIGS. 27-28, in some examples, first end surface 945A (of first side portion 941A) and second end surface 945B (of second side portion 941B) extend generally parallel to each other, with both of the respective end surfaces 945A, 945B extending generally perpendicular to the longitudinal axis A of the main portion 930 and container 900. In some examples, second end surface 945B is spaced apart from the first end surface 945A along an orientation generally parallel to the longitudinal axis (A) of the container 900, with a distance L24 in FIG. 28 between the second end surface 945B and the openable end 922 being less than a distance L1 in FIG. 28 between the first end surface 954 and the openable end 922. In other words, the first end surface 945A is spaced farther from the openable end 922 than the second end surface 945B is spaced from the openable end 922.

Moreover, in some examples the end surface 945B of second side portion 941B comprises an elongate generally rectangular-shaped strip which extends generally parallel to the straight edge portion 971 of first side portion 941A (and of first end surface 945A). In one aspect, the opposite ends of the rectangular strip may have an arcuate shape.

Via this setback between the end surfaces 945A and 945B, a gap G3 is provided for a user to place their fingers about flange 983 and into recess 986 even when the container 900 is in a horizontal orientation, such as in FIGS. 25A-25B, with generally planar bottom portion 941 resting on a surface. As shown in FIGS. 25B and 28, gap G3 has a height L26 which, in some examples, comprises about 5 to about 10 percent of an outer diameter D2 or height H1 of the main portion 930. In some such examples, the first end surface 945A may comprise a height L25 as shown in FIG. 28, with the distances L25 and L26 together being generally equal to the height H1. In some instances, the dimensional indicators L25, L26 may sometimes also be referred to as width, depending on the perspective or view.

As further shown in FIGS. 27-28, the first portion 985A of the end wall 980, which defines the second side portion 941B (including end surface 945B), extends laterally outward relative to the straight edge portion 971 of first side portion 941A of handle portion 940. Meanwhile, as further shown in FIGS. 26A and 27-28, in some examples a second portion 985B of the end wall 980 extends laterally inward relative to the straight edge portion 971 to form a portion of recess 986 beneath flange 983, with second portion 985B facing lower surface 989 of flange 983.

In some examples, the second side portion 941B (including end surface 945B) comprises a single second side portion 941B located on just one side of the first side portion 941A (including end surface 945A). In other words, in some such examples the first side portion 941A is not interposed or sandwiched between a pair of second end portions 941B.

In view of the extra storage volume for a printing material provided via at least the first side portion 941A of the handle portion 940, further information is provided below regarding a relative size of the first side portion 941A and second side portion 941B in at least some examples of container 900. In at least some examples, the larger the cross-sectional area of the first side portion 941A is relative to the cross-sectional area of second side portion 941B, the larger the increase in storage volume may be provided via hollow handle portion 940.

With this in mind and with reference to at least FIG. 25B, in some examples the end surface 945A of first side portion 941A may comprise a first cross-sectional area comprising a majority fraction (e.g. at least 51 percent) of a total cross-sectional area of the main portion 930. In some examples, the second end surface 945B may include a second cross-sectional area comprising a complementary fraction of the total cross-sectional area of the main portion 930 of container 900. In other words, a sum of the first cross-sectional area of the first end surface 945A and of the second cross-sectional area of the second end surface 945B equals a total cross-sectional area of the container 900 at closed end 924. It will be understood that in some examples both end surfaces 945A, 945B each extend in their own respective plane, both of which are perpendicular to a longitudinal axis A of the container 900.

In some examples, the first cross-sectional area of the first end surface 945A comprises at least a supermajority fraction of the total cross-sectional area of main portion 930. Accordingly, in some such examples and as shown in at least FIG. 25B, the relative cross-sectional areas of the respective first and second end surfaces 945A, 945B present an asymmetric appearance.

In some examples, this supermajority fraction may fall within a range between a 60 percent fraction and a 95 percent fraction of the total cross-sectional area of the main portion 930. In some examples, the supermajority fraction comprises at least a 70 percent fraction. In some examples, the supermajority fraction comprises at least a 75 percent fraction. In some examples, the supermajority fraction comprises at least an 80 percent fraction. In some examples, the supermajority fraction comprises at least an 85 percent fraction. In some examples, the supermajority fraction comprises at least a 90 percent fraction. In some examples, the supermajority fraction comprises at least a 95 percent fraction. It will be understood that in some examples, a greater supermajority fraction may result in a greater overall load-carrying capacity (e.g. volume) for container 900 because the volume of the handle portion 940 would be larger when the cross-sectional area of the end surface 945A of the first side portion 941A comprises a larger fraction of the total cross-sectional area of main portion 930.

In some examples, the first side portion 941A (including end surface 945A) is not limited to the particular shape or configuration shown in FIGS. 25A-28, but may exhibit a variety of shapes, edges, etc. while satisfying the threshold of a majority or super majority fraction.

In some examples, a first cross-sectional area of the first end surface 945A may comprise a minority fraction of a total cross-sectional area of the main portion 930 while the second cross-sectional area of the second end surface 945B may comprise a complementary majority fraction of the total cross-sectional area of main portion 930.

In some examples, a size of the first side portion 941A relative to the second side portion 941B also may be expressed according to an arc length (AL in FIG. 25B) of the arcuate outer edge portion 972 of the first side portion 941A. In some such examples, a greater arc length of outer edge portion 972 may correspond to first side portion 941A comprising a larger volume to store printing material within handle portion 940.

For instance, in some examples the first arc length of the outer edge portion 972 comprises at least about 100 to about 179 degrees, which may correspond in some examples to the first side portion 941A (including end surface 945A) comprising a minority fraction of a total cross-sectional area of main portion 930.

However, in some examples the first arc length of the outer edge portion 972 of first side portion 941A comprises at least about 181 to about 350 degrees. This range of arc lengths may correspond in some examples to the first side portion 941A (including end surface 945A) comprising at least a majority fraction, and in some cases a supermajority fraction, of a total cross-sectional area of the main portion 230. In some examples, this arc length may comprise at least 210 degrees. In some examples, this arc length may comprise at least 230 degrees. In some examples, this arc length may comprise at least 260 degrees. In some examples, this arc length may comprise at least 300 degrees. In some examples, the arc length may comprise at least 330 degrees.

As shown in FIG. 25B, in some examples this arc length may comprise at least 280 degrees.

In some examples, the first arc length of the arcuate outer edge portion 972 of the first side portion 941A (including end surface 945A) may be about 180 degrees such that the cross-sectional area of first end surface 945A comprises about one-half (e.g. 50 percent) of the total cross-sectional area of the main portion 930.

Further details regarding the relationship between at least the flange 983, end wall 980, and inner wall 987 of the handle portion 940 are provided below. For instance, in some examples as further shown in FIGS. 26-28B, the flange 983 extends in a plane Y generally perpendicular to the longitudinal axis A of the main portion 930 of the container 900. In some examples, flange 983 extends in a plane Y generally parallel to a plane I through which end wall 980 extends.

As also shown in FIGS. 27-28, from at least one perspective in some examples the inner wall 987 extends in a plane X generally parallel to a central longitudinal axis A of the main portion 930 of the container 900. In some examples, plane X may coincide with the central longitudinal axis A. With this in mind and as shown in at least FIGS. 27-28, in some examples a short axis of the inner wall 987 extends generally parallel to a longitudinal axis A and extends generally perpendicular to the end wall 980.

From another perspective shown in FIG. 26B, in some examples, a longitudinal axis U of the inner wall 987 extends generally perpendicular to the longitudinal axis A of the main portion 930. Accordingly, from this perspective, the recess 986 at least partially defined by the inner wall 987 also has a longitudinal axis U which extends generally perpendicular to the longitudinal axis A of the main portion 930.

Moreover, as shown in at least FIG. 28, in at least some examples the flange 983 may be defined as the portion of first side portion 941A which extends over the recess 986 which extends between portion 985B of end wall 980 and lower surface 989 of flange 983). In some examples, the lower surface 989 defines one side of flange 983 while a portion of end surface 945A of first side portion 941A defines an opposite side of flange 983. Meanwhile, in some examples straight edge portion 971 of end surface 945A of first side portion 941A corresponds to at least an edge surface of flange 983.

As shown in at least FIG. 26A-26B, 28, in some examples the first side portion 941A of handle portion 940 underneath the flange 983 may comprise a pair of spaced apart end walls 990A, 990B which at least partially define the recess 986. Each end wall 990A, 990B extends from, and is connected to, the inner wall 987, portion 985A, and lower surface 989 of flange 983. Moreover, each respective end wall 990A, 990B comprises a respective edge surface 999A, 998B. As shown in at least FIGS. 26A-26B, these edge surfaces 999A, 999B extend from straight edge portion 971 of flange 983 to end wall 980, and as such at least partially define recess 986 as well as at least partially define a boundary or transition between the first side portion 941A (including end surface 945A) and the second side portion 941B (including end surface 945B). In some examples, when viewed as a combination, the edge portion 471 and the two edge surfaces 999A, 999B may be considered a side wall frame or structure in which the recess 986 is formed. Moreover, in some examples, the two edge surfaces 999A, 999B may sometimes be referred to as a pair of spaced apart side wall portions.

In some examples, the two edge surfaces 999A, 999B extend generally perpendicular to end wall 980 and in a plane generally parallel to a longitudinal axis A of the container 900.

As shown in at least FIG. 28, in some examples the end wall 980 comprises a length L30 extending inward from the generally planar bottom portion 914 and into an interior 932 of the main portion 930. In some examples, length L30 may be about one-fourth to three-fourths of the outer diameter D2 (FIG. 26B) or of height H1 (FIG. 28) of main portion 930 of container 900. In some examples, length L30 of end wall 980 may be about one-half of the outer diameter D2 (FIG. 26B) or the height H1 (FIG. 28) of main portion 930 of container 900, as shown in at least FIGS. 27-28. In some such examples, the opening 937 may comprise one-half the outer diameter D2 (FIG. 26B) or the height H1 (FIG. 28).

As shown in at least FIG. 26B, in some examples inner wall 987 comprises a length L28 extending between opposite end walls 990A, 990B, which at least partially define recess 986. In some examples, length L28 may be about 50 percent to about 90 percent of the outer diameter D2 (or height H1) of main portion 930 of container 900. In some examples, this length L28 may be about 70 percent of the outer diameter D2 (or height H1) of main portion 930 of container 900. In some examples, length L28 of the inner wall 987 may correspond to a length of recess 986. In some examples, the length L28 may be on the order of about 125 millimeters.

In some examples, the length L28 of the recess 986 may be greater than a width W25 of the generally planar bottom portion 914 of main portion 930 of container 900, as shown in FIG. 26B.

In some examples, this length L28 of recess 986 also comprises the length L28 of the finger-grippable lower surface 989 of flange 983. In some examples, this length L28 may facilitate the above-described full-gripping of flange 983 in which all four fingers may be wrapped about the flange 983 with the fingers extending within the recess 986. Meanwhile, a thumb of the same hand may be positioned on the outer side wall 973 of first side portion 941A of handle portion 940 such that an opposing thumb-finger gripping action may take place to securely grasp handle portion 940 and therefore securely handle container 900.

As shown in at least FIG. 28, in some examples the inner wall 987 (and therefore recess 986) may comprise a width W20 which is substantially greater than (e.g. 2×, 3×) a thickness or width W21 of flange 983. However, in some examples where flange 983 may be relatively thicker, the width W20 of the inner wall 987 (and therefore of recess 986) may be the same as or less than a thickness or width W21 of the flange 983.

With this in mind and as shown in at least FIG. 28, in some examples the handle portion 940 may comprise a width W22 which is about 10 percent to about 20 percent of the length L1 of the container 900. In some examples, the width W22 is about 17 percent of the length L2. In some such examples, the width W22 may be on the order of about 75 millimeters, such as when the overall length of the container 900 may be on the order of about 450 to 500 millimeters. To the extent that at least some examples may refer to at least the first side portion 941A of handle portion 940 as comprising an at least partially disc-shaped body B, then the width W22 may sometimes be referred to as a thickness of the at least partially disc-shaped body B and/or a thickness of the handle portion 940.

In one aspect, the orientation of a longitudinal axis U (e.g. FIG. 26B) of the recess 986 (and of grippable surface 989 of flange 983) of handle portion 940 may be generally parallel to a plane P (FIG. 25B) through which the general planar portion 914 extends, which in turn, may facilitate handling of container 900 during loading to ensure a correct orientation of insertion of container 900 into a receiving portion (e.g. slot 280) of a material supply of a 3D printer (FIGS. 6-7). In particular, this particular orientation of handle portion 940 provides a one handed supinated-grip which, in turn, may ease manually raising the main portion 930 of the container 900 from a vertical orientation (e.g. FIG. 26) to a horizontal orientation (e.g. FIG. 25A). In such arrangements, a second hand may support the main portion 930 of container 900. Such selective rotation of container 900 may facilitate positioning the container 900 for placement onto a storage shelf and/or for slidable insertion into a receiving portion (e.g. slot 280 in FIGS. 6-7) of a material supply of a 3D printer (FIG. 8).

Moreover, in some examples, the inner wall 987 which at least partially defines recess 986 may also be considered as a grippable element of handle portion 940 at least to the extent that a user's fingers may releasably contact and engage the inner wall 987. In some instances, such as when rotating the container 900 from a vertical orientation (FIG. 26A) to a horizontal orientation (FIG. 25A), the inner wall 987 of handle portion 940 may significantly enhance lifting leverage on the container 900. In addition, in some examples a user's fingertips may more easily move individually relative to each other in this position (e.g. greater manual dexterity). Via such arrangements, it may be easier to exert fine motor control in making fine adjustments in a left-to-right tilting orientation or rotational orientation of the container 900, such as during slidable insertion into a receiving portion of a material supply of a 3D printer (FIGS. 6-8).

Meanwhile, the arrangement of the longitudinal axis U of the recess 986 (to be generally perpendicular to the longitudinal axis A of the main portion 930) as shown in at least FIG. 26B may facilitate carrying the container 900 in one of several different orientations, such as a neutral hand grip (in which the palm faces the side of the body), a pronated hand grip (in which the palm faces backward), or a supinated hand grip (in which the palm faces forward).

In some examples, at least the portion of the flange 983 extending between the opposite end walls 990A, 990B may sometimes be referred to as a hand-grippable elongate segment of the handle portion 940 in a manner similar to the elongate segments of the respective example containers 200, 600, 700, 800. Via this arrangement, the elongate segment at least partially defined by the flange 983 is spaced apart from end wall 980 of main portion 930 to create open space (e.g. recess 986) between end wall 980 and flange 983. In at least this context, the recess 986 may sometimes be referred to as a partial void to the extent that a space extends between the flange 983 and the end wall 980 of container 900. However, inner wall 987 of container 900 prevents a user from using their fingers to completely encircle flange 983 in a gripping action as in the elongate segments of the handle portions of the respective example containers 200, 600, 700, 800, and as such handle portion 940 does not comprise a complete void between flange 983 and end wall 980.

In some examples, at least the curved shape of the arcuate outer edge portion 972 of the first side portion 941A of the handle portion 940 may facilitate flowability of a printing material within the hollow interior 939 of the handle portion 940, such as when the container 900 is rotated via a receiving portion of a material supply of a 3D printer (FIGS. 6-8). This arrangement may, in turn, facilitate automatic migration of printing material from handle portion 940, through opening 937, and into interior 932 of main portion 930 upon printing material being selectively withdrawn via the openable end 922 (e.g. typically sealed via element 50 as in FIGS. 1-2A) of the container 900. In this way, the printing material may be automatically repositioned along, and within, substantially entire length of container 900, including within hollow handle, during rotation of container. Upon selective re-entry of material into container via the openable end 922, material may re-enter handle portion 940 in an analogous manner.

In some examples, container 900 may provide a substantially increased volume (e.g. about 12 liters) for generally the same length L1 as one of the other example containers (e.g. 200 in FIGS. 4A-5A), which generally may have a volume on the order of 10 Liters. Accordingly, container 900 may provide at least up to a 20% increase in carrying a volume of printing material within the same overall dimensions (e.g. length, outer diameter) as at least some of the containers (e.g. 200, 600, etc.) having a loop-style handle portion (e.g. 240, 640, etc.). In some examples, a storable volume of the handle portion 940 may comprise at least 10 percent of a total storable volume of the container 200. In some examples, the storable volume of the handle portion 940 may comprise at least 15 percent of a total storable volume of the container 200. In some examples, the storable volume of the handle portion 940 may comprise at least 20 percent of a total storable volume of the container 200. Via at least some such example arrangements, container 900 also may enhance operational efficiency by reducing the frequency with which a material supply is to be replenished via a consumable printing material container, such as container 900. This, in turn, may reduce overall operating costs, inventory control costs, storage costs, shipping costs, etc. associated with providing a reliable, timely supply of printing material for a 3D printer.

With these example arrangements in mind, it is further noted that as shown in FIGS. 25A-28, in some examples the outer side wall 973 of first side portion 941A does not include a grippable recess or protrusion. However, in some examples the outer side wall 973 of first side portion 941A may be modified to have at least one minor recess and/or at least one minor protrusion to enhance gripping of outer side wall 973 with a thumb while the fingers of the grasping hand releasably engage recess 986 of handle portion 940.

In some examples the flange 983 comprises the sole grippable flange 983 of handle portion 940.

As shown in FIGS. 26A-28, the handle portion 940 comprises a single recess 986 in association with grippable flange 983. However, it will be understood that in some examples the space occupied by recess 986 in the examples shown in these Figures may be apportioned as at least two recesses.

In some examples, the second side portion 941B of handle portion 940 may comprise flange 983 formed as a grippable protrusion while omitting the recess 986.

In some examples, the second end surface 945B (of second side portion 941B) comprises a single second end surface. Stated differently, in some examples the second end surface 945B comprises the sole second end surface of closed end 924 of container 900.

In some examples, at least a portion of one of the example hollow handle portions of the example containers 200, 600, 700, 800, 900 can be modified to be solid, so as to not store printing material or to store less printing material. In some such examples, other features of the example handle portions may still be implemented.

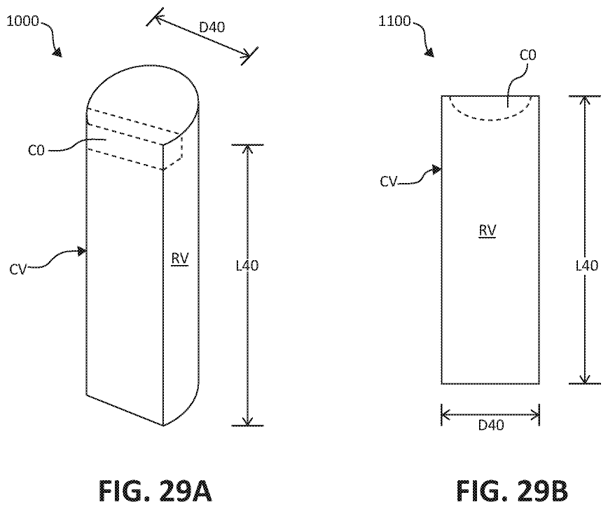

FIGS. 29A-29B are each a diagram 1000, 1100 respectively schematically representing an example calculated volume CV for an example container to supply a printing material for a 3D printer. As shown in FIGS. 29A-29B, each diagram 1000, 1100 represents a calculated volume CV of a container, which has a length L40 and a diameter D40. In these examples, the calculated volume (CV) would correspond to a container which has not been formed with a handle such as one of the handles in at least example container 800 of FIGS. 19-23B or container 900 of FIGS. 25A-28. As previously noted, in some examples in which the container may comprise a non-circular cross-sectional shape, the dimensional indicator D40 also may sometimes represent an average diameter, distance between opposite sides, or similar dimensional attribute.

Accordingly, in at least some examples each diagram 1000, 1100 represents a volume of a container in the absence of a handle, such as if a cross-sectional shape (e.g. 111 in FIG. 3) were generally maintained throughout a full length of a container. In some examples, this calculated volume (CV) of an example container in the diagrams 1000, 1100 may generally correspond to a volume of a frame 302 (FIG. 7) having a size and shape (e.g. length L40 and diameter D40) to receive such example container. Accordingly, in some such examples, this calculated volume (CV) may be considered a maximum volume of a container receivable by the frame 302 (or appropriately shaped slot 280) of a material supply 275 of a 3D printer (FIGS. 6-7).

With this in mind, in some examples a hollow handle portion may be implemented for a container via forming a portion of a side wall of and/or an end wall of a closed end of an example container in order to facilitate grasping the container for carrying and/or insertion into a receiving portion (e.g. slot 280 in FIGS. 6-7) of a material supply of a 3D printer. The formed side wall and/or end wall may define a recess and/or void, in a manner at least substantially the same as in at least the previously described example containers 800 (FIGS. 19-23B), 900 (FIGS. 25A-28).

In some such examples, upon forming such recessed end wall or side wall, some of the potentially maximum or calculated volume (CV) may be referred to as having been cut-out or removed in order to implement or form a handle portion for the container. In some such examples, the actually formed container may be considered a remaining volume (RV) of the calculated volume (CV) and may sometimes be referred to as a first volume.

For instance, in the diagrams 1000, 1100 of FIGS. 29A, 29B, the dashed lines indicated by reference indicator CO represents a volume cut-out from a calculated volume (CV) of the container in order to form a handle. In some instances, the cut-out volume (CO) may sometimes be referred to as a second volume. In some examples, the cut-out volume (CO) in diagram 1000 in FIG. 29A may generally be associated with, and generally correspond to, formation of the handle portion 940 of example container 900 in FIGS. 24A-28. In some examples, the cut-out volume (CO) in diagram 1100 in FIG. 29B may generally be associated with, and generally correspond to, formation of the handle portion 840 of example container 800 in FIGS. 19-23B.

In some examples, the cut-out volume (CO) represented in FIGS. 29A, 29B corresponds to about 5 percent of the calculated volume (CV) while a remaining volume (RV) defined by the actual container may be about 95% of the calculated volume (CV). Accordingly, the difference between the remaining volume (e.g. first volume) and the calculated volume generally equals a second volume defined by the recess or cut-out.

In some examples, the remaining volume (RV) represented in FIGS. 29A, 29B of the actual container may be between about 80% to 95% of the calculated volume (CV), depending on the size and shape of the handle portion defined by forming a side wall and/or end wall to implement the handle portion.

It may be understood that in at least some examples, to the extent that a hollow handle portion may be implemented (via formation of a side wall and/or end wall) while minimizing the size of the cut-out volume (CO), the greater the remaining volume (RV) of the actual container may be relative to the given constraints of a length L40 and a diameter D40 of a frame 302 and/or slot 280 (FIGS. 6-7) to receive the supply container.

It will be understood that in some examples the handle portion formed may incorporate a wide range of sizes and/or shapes, and that example containers 800, 900 (as well as 200, 600, 700) represent just some examples of the types of handles which may be formed while maximizing a volume of a container.

Via at least some such example arrangements in association with FIGS. 29A-29B, a supply container may be implemented with a relatively larger storage capacity while still providing an ergonomic and practical handle portion for carrying and/or removably inserting the supply container.

FIG. 30A is a block diagram schematically representing an example control portion 1200. In some control portion 1200 provides one example implementation of a control portion forming a part of, implementing, and/or managing a material supply, 3D printer, container 3D printing instructions, engines, and/or methods, as described throughout examples of the present disclosure in association with FIGS. 1-28 and 30B-31.

In some examples, control portion 1200 includes a controller 1202 and a memory 1210. In general terms, controller 1202 of control portion 1200 comprises at least one processor 1204 and associated memories. The controller 1202 is electrically couplable to, and in communication with, memory 1210 to generate control signals to direct operation of the material supply (at least FIGS. 6-8), 3D printer (at least FIGS. 6-8), implement container 3D printing instructions, operate an engine, and/or perform methods, as described throughout examples of the present disclosure. In some examples, these generated control signals include, but are not limited to, employing instructions 1211 stored in memory 1210 to at least direct and manage additive manufacturing (e.g. 3D printing) of 3D objects in the manner described in at least some examples of the present disclosure. In some examples, generating or processing such instructions 1211 may comprise generating or processing instructions 1211 to additively manufacture (e.g. 3D print) any one of the containers (or a portion of such containers) having at least some of the features and attributes as previously described in association with at least FIGS. 1-7 and 9-28.

In response to or based upon commands received via a user interface (e.g. user interface 1220 in FIG. 30B) and/or via machine readable instructions, controller 1202 generates control signals to implement additive manufacturing of a 3D object in accordance with at least some of the examples of the present disclosure. In some examples, controller 1202 is embodied in a general purpose computing device while in some examples, controller 1202 is incorporated into or associated with implementation of a material supply, 3D printer, container 3D printing instructions, engines, and/or methods as described throughout examples of the present disclosure.

For purposes of this application, in reference to the controller 1202, the term “processor” shall mean a presently developed or future developed processor (or processing resources) that executes sequences of machine readable instructions contained in a memory. In some examples, execution of the sequences of machine readable instructions, such as those provided via memory 1210 of control portion 1200 cause the processor to perform actions, such as operating controller 1202 to implement additive manufacturing of 3D objects as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 1210. In some examples, memory 1210 comprises a computer readable tangible medium providing non-volatile storage of the machine readable instructions executable by a process of controller 1202. In other examples, hard wired circuitry may be used in place of or in combination with machine readable instructions to implement the functions described. For example, controller 1202 may be embodied as part of at least one application-specific integrated circuit (ASIC). In at least some examples, the controller 1202 is not limited to any specific combination of hardware circuitry and machine readable instructions, nor limited to any particular source for the machine readable instructions executed by the controller 1202.

In some examples, control portion 1200 is entirely implemented within an additive manufacturing device (e.g. 3D printer), which has at least some of substantially the same features and attributes as 3D printer 400 as previously described in association with at least FIG. 8. In some examples, the control portion 1200 is partially implemented in the 3D printer 400 and partially implemented in a computing resource separate from, and independent of, the 3D printer 400 but in communication with the 3D printer 400.

In some examples, control portion 1200 may be implemented independently of a 3D printer 400, such as for generating 3D printing instructions to be stored in a non-transitory computer readable medium, which then may be separately or later transmitted (or otherwise delivered) to a 3D printer for printing a 3D object according to those instructions. In some examples, generation and/or processing the 3D printing instructions may involve obtaining a 3D image of a sample 3D object, such as via a 3D scanner or other imaging device.

In some examples, control portion 1200 includes, and/or is in communication with, a user interface 1220 as shown in FIG. 30B. In some examples, user interface 1220 comprises a user interface or other display that provides for the simultaneous display, activation, and/or operation of at least some of the material supply, 3D printer, container 3D printing instructions, engines, and/or methods, as described in association with FIGS. 1-28 and 30B-31. In some examples, at least some portions or aspects of the user interface 1220 are provided via a graphical user interface (GUI), and may comprise a display 1224 and input 1222.

FIG. 30C is a block diagram schematically representing an example container 3D printing instruction engine 1250. In some examples, container 3D printing instruction engine 1250 provides one example implementation of instructions 1211 in control portion 1200 in FIG. 30A suitable for operation of 3D printer (e.g. 400 in FIG. 8) to additively manufacture a 3D container. In some examples, container 3D printing instruction engine 1250 comprises at least some of substantially the same features and attributes of instructions 1211 and/or control portion 1200 generally in association with FIG. 30A.

In some examples, the container 3D printing instruction engine 1250 generates and/or processes instructions for use with a 3D printer (e.g. 400 in FIG. 8) to direct and manage additive manufacturing of a 3D object, such as manufacture of any one of the containers (or portions thereof) as previously described in association with FIGS. 1-28. In some examples, container 3D printing instruction engine 1250 may incorporate and/or implement the method of 3D printing a container as described in association with at least FIG. 31.

FIG. 31 is a flow diagram schematically representing an example method 1400 of 3D printing an example container.

In some examples, method 1400 is performed via at least some of the 3D printer, control portion, instructions, engine (as previously described in at least FIGS. 6-8, 30A-30C) to 3D print any one of the example containers (or a portion thereof) as previously described in association with at least FIGS. 1-7 and 8-28. In some examples, method 1400 is performed via at least a 3D printer, control portion, instructions, engines other than those previously described in association with at least FIGS. 6-8 and 30A-30C. In some examples, method 1400 may comprise a portion of and/or be implemented via at least a container 3D printing instruction engine, such as engine 1250 in FIG. 30C.

As shown at 1402 in FIG. 31, in some examples method 1400 comprises forming an elongate hollow container to store a printing material and to include a main portion, an openable end, and an opposite closed end. At 1404, method 1400 may comprise forming the closed end to be at least partially defined by a hollow handle portion in fluid communication with the main portion.

In view of the example containers described in association with FIGS. 1-31, at least some further example containers are described below.

In some examples, a container comprises an elongate hollow main portion to store a printing material. The main portion comprises an openable end and an opposite closed end. The closed end includes an end wall of the main portion and a hollow handle portion spaced apart from the end wall, wherein the hollow handle portion is in fluid communication with the main portion. In some examples, at least a portion of the openable end of the main portion is removably insertable into a receiving portion of a material supply of a 3D printer or of an element of a 3D printing system.

In some examples, the main portion comprises a reservoir including an at least partially cylindrical shape.

In some examples, a greatest cross-sectional dimension of an open end of a container comprises about 50 to 100 percent of a greatest cross-sectional dimension of a remainder of a main portion of the container. In some examples, the greatest cross-sectional dimension comprises a diameter, an average diameter, a height, a distance between opposite sides of the container, or similar dimensional attribute.

In some examples, a rotational axis of the container is aligned with (e.g. coaxial) and/or generally parallel to a longitudinal axis of the container.

In some examples, at least a portion of the hollow handle portion comprises a cross-sectional shape arranged as at least one of a circular shape, rectangular shape, an arcuate shape, an elliptical shape, a triangular shape, a trapezoidal shape, and n-gon shape.

In some examples, the hollow handle portion comprises an elongate segment having a length at least one half a greatest cross-sectional dimension of the main portion. In some examples, the hollow handle portion comprises an elongate segment having a length generally corresponding to greatest cross-sectional dimension of the main portion.

In some examples, the hollow handle portion is separate from the main portion of the container and connectable to the first end of the container.

In some examples, the hollow handle portion comprises a volume which is about 5 percent to about 10 percent of a total volume of container.

In some examples, the hollow handle portion comprises a cross-sectional area having a minimum inner diameter which is substantially greater than an average size of printing material particles to be stored within the container.

In some examples, a method comprises forming an elongate hollow container to store a printing material and to include a main portion, an openable end, and an opposite closed end. The closed end is formed to be at least partially defined by a hollow handle portion in fluid communication with the main portion.

In some examples, a non-transitory computer readable medium storing machine readable instructions, executable on a processing resource, to generate or process 3D printing instructions to cause formation of an elongate hollow container to store a printing material and to include a main portion, an openable end, and an opposite closed end. The 3D printing instructions are to cause formation of the closed end as at least partially defined by a hollow handle portion in fluid communication with the main portion.

In some examples, a container 3D printing instruction engine comprises the machine readable instructions to cause formation of the container and the hollow handle portion, according to at least some of the features and attributes as described above in association with at least FIGS. 1-31.

In some examples, a processor is to execute, machine readable instructions stored in a non-transitory computer readable medium to generate or process 3D printing instructions to cause formation of an elongate hollow container to store a printing material and to include a main portion, an openable end, and an opposite closed end. The 3D printing instructions are to cause formation of the closed end as at least partially defined by a hollow handle portion in fluid communication with the main portion.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A container comprising:
an at least partially cylindrically-shaped shell including a main portion to store a printing material, the shell including:
an openable end; and
an opposite closed end including an end wall of the main portion and a hollow handle portion spaced apart from the end wall, wherein the hollow handle portion is in fluid communication with the main portion,
wherein at least the openable end of the main portion is removably insertable into a receiving portion of an element of a 3D printing system.

2. The container of claim 1, wherein the hollow handle portion and the main portion are molded as a single, unitary piece.

3. The container of claim 1, wherein the closed end comprises an end wall and the hollow handle portion comprises an elongate segment spaced apart from the end wall by a first distance to define a void between the end wall and the elongate segment.

4. The container of claim 3, wherein a longitudinal axis of the elongate segment of the handle portion is generally perpendicular to a longitudinal axis of the main portion.

5. The container of claim 3, wherein the first distance is at least about one-half a greatest cross-sectional dimension of the main portion.

6. The container of claim 3, wherein the elongate segment comprises a first end and an opposite second end and wherein the hollow handle portion comprise:
a first hollow transition portion extending from the first end of the elongate segment to the end wall of the main portion; and
a second hollow transition portion extending from the second end of the elongate segment to the end wall of the main portion.

7. The container of claim 6, wherein at least one of the respective first and second hollow transition portions comprises a generally trapezoidal shape.

8. The container of claim 6, wherein at least the first segment of the hollow handle portion is spaced apart from the end wall of the main portion of shell by a first distance to define a void between the end wall and at least the first segment, and
wherein the first hollow transition portion is spaced apart from the second opposite hollow transition portion by a second distance, which is substantially greater than the first distance.

9. The container of claim 6, wherein the first respective hollow transition portion is spaced apart from the second hollow transition portion by a second distance, which is substantially greater than a greatest cross-sectional dimension of the elongate segment of the hollow handle portion.

10. The container of claim 1, wherein the container comprises a central longitudinal axis about which the container is rotatable and wherein the openable end comprises a structure through which the printing material is selectively movable in and out of the container depending on a direction of rotation of the container.

11. A handle comprising:
an elongate hollow element to store printing material, wherein the element extends from, and is in fluid communication with, a first end of a hollow container to hold printing material, the hollow element being spaced apart from an end wall of the first end to define a void between the hollow element and the end wall of the first end,
wherein the handle is to facilitate removable slidable insertion of a second end of the container into a receiving portion of an element of an additive manufacturing device.

12. The handle of claim 11, wherein the elongate hollow element comprises two opposite ends, which are each connectable relative to the closed end to define a respective opening to provide the fluid communication, and wherein the elongate hollow element is generally perpendicular to a longitudinal axis of the hollow container.

13. The handle of claim 11, wherein the elongate hollow element comprises a length more than one-half a greatest cross-sectional dimension of the hollow container.

14. A container comprising:
an elongate hollow reservoir to store a 3D printing material, the hollow reservoir including an openable end and an opposite closed end, which comprises an end wall and a hollow loop portion extending from at least the end wall,
wherein the hollow loop portion is in fluid communication with an interior of the hollow reservoir and comprises an elongate segment spaced apart from the end wall to define a void between the elongate segment and the end wall.

15. The container of claim 14, wherein the loop portion comprises about 5 to 10 percent of a total storage volume of the container.
